(19) United States
(12) Patent Application Publication
(10) Pub. No.: US 2005/0071306 A1
(43) Pub. Date: Mar. 31, 2005

(54) Method and system for on-screen animation of digital objects or characters

(76) Inventors: Paul Kruszewski, Westmount (CA); Vincent Stephen-Ong, Montreal (CA); Muthana Kubba, Montreal (CA); Fred Dorosh, Montreal (CA); Julianna Lin, Rochester, NY (US); Nicolas Leonard, Montreal (CA); Greg Labute, Montreal (CA); Cory Kumm, Saint-eustache (CA); Richard Norton, Pierrefonds (CA)

Correspondence Address: Fay Kaplun & Marcin, LLP;Suite 702, 150 Broadway, New York, NY, 10038, US

(21) Appl. No.: 10/772,028

(22) Filed: Feb. 3, 2004

Related U.S. Application Data
(60) Provisional application No. 60/444,879, filed on Feb. 5, 2003.

(51) Int. Cl. G06N 5/02; A63F 9/24; G06T 15/70

(52) U.S. Cl. 706/47; 463/32; 345/473

(57) ABSTRACT

The method for on-screen animation includes providing a digital world including image object elements and defining autonomous image entities (AIE). Each AIE may represent a character or an object that is characterized by i) attributes defining the AIE relatively to the image objects elements of the digital world, and ii) behaviours for modifying some of the attributes. Each AIE is associated to animation clips allowing representing the AIE in movement in the digital world. Virtual sensors allow the AIE to gather data information about image object elements or other AIE within the digital world. Decision trees are used for processing the data information resulting in selecting and triggering one of the animation cycle or selecting a new behaviour. A system embodying the above method is also provided. The method and system for on-screen animation of digital entities according to the present invention can be used for creating animation for movies, for video games, and for simulation.

### FIELD OF THE INVENTION

The present invention relates to the digital entertainment industry and to computer simulation. More specifically, the present invention concerns a method and system for on-screen animation of digital objects or characters.

### BACKGROUND OF THE INVENTION

It's the nature of the digital entertainment industry to continuously push the boundaries of creativity. This drive is very strong in the fields of three-dimensional (3D) animation, visual effects and gaming. Hand animation and particle systems are reaching their natural limits.

Procedural animation, which is driven by artificial intelligence (AI) technique is the new frontier. AI animation allows augmenting the abilities of digital entertainers across disciplines. It gives game designers the breadth, independence and tactics of film actors. Film-makers get the depth and programmability of an infinite number and real time game style characters.

Until recently, the field of AI animation was limited to a handful of elite studios with a large development team that developed their own expensive proprietary tools. This situation is akin to the case of early filmmakers such as the Lumiere Brothers, who had no choice but to build their own cameras.

For over twenty years, the visual effects departments of film studios have increasingly relied on computer graphics for whenever a visual effect is too expensive, too dangerous or just impossible to create any other way than via a computer. Unsurprisingly, the demands on an animator's artistic talent to produce even more stunning and realistic visual effects have also increased. Nowadays, it is not uncommon that the computer animation team is just as important to the success of a film as the lead actors.

Large crowd scenes, in particular battle scenes, are ideal candidates for computer graphics techniques since the sheer number of extras required make them extremely expensive, their violent nature make them very dangerous, and the use of fantastic elements such as beast warriors make them impractical, if not impossible, to film with human extras. Given the complexity, expense, and danger of such scenes, it is clear that an effective artificial intelligence (AI) animation solution is preferable to actually staging and filming such battles with real human actors. However, despite the clear need for a practical commercial method to generate digital crowd scenes, a satisfactory solution has been a long time in coming.

Commercial animation packages such as Maya™ by Alias Systems have made great progress in the last twenty years to the point that virtually all 3D production studios rely on them to form the basis of their production pipelines. These packages are excellent for producing special effects and individual characters. However, crowd animation remains a significant problem.

According to traditional commercial 3D animation techniques, animators must laboriously keyframe the position and orientation of each character frame by frame. In addition to requiring a great deal of the animator's time, it also requires expert knowledge on how intelligent characters actually interact. When the number of characters to be animated is more than a handful, this task becomes extremely complex. Animating one fish by hand is easy; animating fifty (50) fish by hand can become time consuming.

Non-linear animation techniques such as Maya's Trax Editor™, try to reduce the workload by allowing the animator to recycle clips of animations in a way that is analogous to how sound clips are used. According to this clip recycling technique, an animator must position, scale, and composite each clip. Therefore, to make a fish swim across a tank and turn to avoid a rock, the animator repeats and scales the swim clip and then adds a turn clip. Although this reduces the workload per character, it still must be repeated for each individual character, e.g. the fifty (50) fish.

Rule-based techniques present a more practical alternative to their laborious keyframe counterparts. Particle systems try to reduce the animator's burden by controlling the position and orientation of the character via simple rules. This is effective for basic effects such as a school of fish swimming in a straight-line. However the characters do not avoid each other and they all maintain the exact same speed. Moreover, animation clip control is limited to simple cycling. For example, it is very difficult to get a shark to chase fish and the fish to swim away, let alone for the shark to eat the fish and have them disappear.

A solution to this problem is to develop an AI solution in-house. Writing proprietary software may present the animator with the ability to create a package specifically designed for a given project, but it is often an expensive and risky proposition. Even if the necessary expertise can be found, it is most often not in the company's best interest to spend time and money on a non-core competency. In the vast majority of cases, the advantages of buying a proven technology outweigh this expensive, high-risk alternative.

In the computer game field, game AI has been in existence since the dawn of video games in the 1970s. However, it has come a long way since the creation of Pong™ and Pac-Man™. Nowadays, game AI is increasingly becoming a critical factor to a game's success and game developers are demanding more and more from their AI. Today's AI need to be able to seemingly think for themselves and act according to their environment and their experience giving the impression of intelligent behaviour, i.e. they need to be autonomous.

Game AI makes games more immersive. Typically game AI is used in the following situations:
to create intelligent non-player characters (NPCs), which could be friend or foe to the player-control characters;
to add realism to the world. Simply adding some none essential game AI that reacts to the changing game world can increase realism and enhance the game experience. For example, AI can be used to fill sporting arenas with animated spectators or to add a flock of bats to a dungeon scene;
to create opponents when there are none. Many games are designed for two or more players however, if there is no one to play against intelligent AI opponents are needed; or
to create team members when there are not enough. Some games require team play, and game AI can fill the gap when there are not enough players.

Typically, in a conventional computer game, the main loop contains successive calls to the various layers of the virtual world, which could include the game logic, AI, physics, and rendering layers. The game logic layer determines the state of the agent's virtual world and passes this information to the AI layer. The AI layer then decides how the agent reacts according to the agent's characteristics and its surrounding environment. These directions are then sent to the physics layer, which enforces the world's physical laws on the game objects. Finally, the rendering layer uses data sent from the physics layer to produce the onscreen view of the world.

### OBJECTS OF THE INVENTION

An object of the present invention is therefore to provide an improved method and system for on-screen animation of digital entities.

### SUMMARY OF THE INVENTION

A method and system for on-screen animation of digital entities according to the present invention allows controlling the interaction of image entities within a virtual world. Some of the digital entities are defined as autonomous image entities (AIE) that can represent characters, objects, virtual cameras, etc, that behave in a seemingly intelligent and autonomous way. The virtual world includes autonomous and non-autonomous entities that can be graphically represented on-screen in addition to other digital representation which can or cannot be represented graphically on a computer screen or on another display.

Generally stated, the method and system allows generating seemingly intelligent image entities motion with the following properties:

1) Intelligent Navigation

Intelligent navigation in a world is handled on two conceptual levels. The first level is purely reactive and it includes autonomous image entities (AIE) attempting to move away from intervening obstacles and barriers as they are detected. This is analogous to the operation of human instinct in reflexively pulling one's hand away from a hot stove.

The second level involves forethought and planning and is analogous to a person's ability to read a subway map in order to figure out how to get from one end of town to the other.

Convincing character navigation is achieved by combining both levels. Doing so enables a character to navigate paths through complex maps while at the same time being able to react to dynamic obstacles encountered in the journey.

2) Intelligent Animation Control

In addition to being seemingly intelligently moved within the virtual world, AIEs' animations can be driven based on their stimuli.

The simplest level of animation control allows to, for example, play back an animation cycle based on the speed of motion of a character's travel. For example, a character's walk animation can be scaled according to the speed of its movement.

On a more complex level, AIEs can have multiple states and multiple animations associated with those states, as well as possible special-case transition animations when moving from state to state. For example, a character can seamlessly run, slow down as it approaches a target, blending through a walk cycle and eventually ending up at, for example, a “talk” cycle. The resulting effect is a character that runs towards another character, slows down and starts talking to them.

3) Interactivity

By specifying reactive-level and planning-level, AIEs can adapt to a changing environment.

A method and system for on-screen animation of digital entities according to the present invention allows defining an AIE that is able to navigate a world while avoiding obstacles, dynamic or otherwise. Adding more obstacles or changing the world can be achieved in the virtual world representation, allowing characters to understand their environment and continue to be able to act appropriately within it.

It is to be noted that the expression “virtual world” and “digital world” are interchangeable herein.

AIEs' brains can also be described with complex logic via a subsystem referred to herein as “Action Selection”. Using sensors to read information about the virtual world, decision trees to understand that information, and commands to execute resulting actions, AIEs can accomplish complex tasks within the virtual world, such as engaging in combat with enemy forces.

A system for on-screen animation of digital entities according to the present invention may include:

A) A solver

The system includes an Autonomous Image Entity Engine (AIEE). The engine calculates and updates the position and orientation of each character for each frame, chooses the correct set of animation cycles, and enables the correct simulation logic. Within the Autonomous Entity Engine is the solver, which allows the creation of intelligent entities that can self-navigate in the geometric world. The solver drives the AIEs and is the container for managing these AIEs and other objects in the virtual world.

B) Autonomous And Non-Autonomous Image Entities, Including Groups of Image Entities

Image entities come in two forms: autonomous and non-autonomous. In simple terms, an autonomous image entity (AIE) acts as if it has a brain and is controlled by in a manner defined by attributes it has been assigned. The solver controls the interaction of these autonomous image entities with other entities and objects within the world. Given this very general specification, an AIE can control anything from a shape-animated fish, a skeletal-animated warrior, or a camera. Once an AIE is defined it is assigned characteristics, or attributes, which define certain basic constraints about how the AIE is animated.

A non-autonomous image entity does not have a brain and must be manipulated by an external agent. Non-autonomous image entities are objects in the virtual world that, even though they may potentially interact with the world, are not driven by the solver. They can include objects such as player-controlled characters, falling rocks, and various obstacles.

Once an AIE is defined, characteristics or attributes, which define certain basic constraints about how the AIE can move, are assigned thereto. Attributes include, for example, the AIE's initial position and orientation, its maximum and minimum speed and acceleration, how quickly it can turn, and if the AIE hugs a given surface. These constraints will be obeyed when the AIE's position and orientation are calculated by the solver. The AIE can then be assigned pertinent behaviours to control its low-level locomotive actions. Behaviours generate steering forces that can change an AIE's direction and/or speed for example. Without an active behaviour, an AIE would remain moving in a straight line at a constant speed until it collided with another object.

Non-autonomous characters are objects in the digital world that, even though they may potentially interact with the world, are not driven by the solver. These can range from traditionally animated characters (e.g. the leader of a group) to objects (e.g. boulders and trees) driven by a dynamic solver. The method and system according to the present invention allows interaction among characters. For example, a group of autonomous characters could follow a non-autonomous leader character animated by traditional means, or the group could run away from a physics-driven boulder.

C) Paths and Waypoint Networks

Paths and waypoint networks are used to guide an AIE within the virtual world.

A path is a fixed sequence of waypoints that AIEs can follow. Each waypoint can be assigned speed limits to control how the AIE approaches it (e.g. approach this waypoint at this speed). Paths can be used to build racetracks, attack routes, flight paths, etc.

A waypoint network allows defining the “navigable” space in world, clearly defining to AIEs what possible routes they can take in order to travel from point to point in the world.

D) Behaviours

Behaviours provide AIEs with reactive-level properties that describe their interactions with the world. An AIE may have any number of behaviours that provide it with such instincts as avoiding obstacles and barriers, seeking to or fleeing from other characters, “flocking” with other characters as group, or simply wandering around.

Behaviours allow producing “desired motion” and desires from multiple behaviours can be combined to produce a single desired motion for the AIE to follow. Behaviour intensities (allowing scaling up or down of a behaviour's produced desired motion), behaviour priorities (allowing higher priority behaviours to completely override the effect of lower priority ones), and behaviour blending (allowing a behaviour's desired motion to be “fade in” and “fade out” over time), can be used to control the relative effects of different behaviours.

E) Action Selection

Action Selection allows enabling AIEs to make decisions based on information about their surrounding environment. As Behaviours can be thought of as instincts, Action Selection can be thought of as higher-level reasoning, or logic.

Action Selection is fuelled by “sensors” that allow AIEs to detect various kinds of information about the world or about other AIEs.

Results of sensors' detections are saved into “datum” and this data can be used to drive binary decision trees, which provide the “if . . . then” logic defining a character's high-level actions.

Finally, obeying a decision tree causes the character to make a decision, which is basically a group of commands. These commands provide the character with the ability to modify its behaviours, drive animation cycles, or update its internal memory.

F) Animation Control

Another feature of a method for on-screen animation of digital entities according to the present invention is its ability to control an AIE's animations based on events in the world. By defining animation cycles and transitions between animations, the method can be used to efficiently create a seamless, continuous blend of realistic AI-driven character animation.

More specifically, in accordance with a first aspect of the present invention, there is provided a method for on-screen animation of digital entities comprising:
providing a digital world including image object elements;
providing at least one autonomous image entity (AIE); each the AIE being associated with at least one AIE animation clip, and being characterized by a) attributes defining the at least one AIE relatively to the image objects elements, and b) at least one behaviour for modifying at least one of the attributes; the at least one AIE including at least one virtual sensor for gathering data information about at least one of the image object elements or other one of the at least one AIE;
initializing the attributes and selecting one of the behaviours for each of the at least one AIE;
for each the at least one AIE:
   using the at least one sensor to gather data information about at least one of the image object elements or other one of the at least one AIE; and
   using a decision tree for processing the data information resulting in at least one of i) triggering one of the at least one AIE animation clip according to the attributes and selected one of the at least one behaviour, and ii) selecting one of the at least one behaviour.

According to a second aspect of the present invention, there is provided a system for on-screen animation of digital entities comprising:
an art package to create a digital world including image object elements and at least one autonomous image entity (AIE) and to create AIE animation clips; and
an artificial intelligence agent to associate to an AIE a) attributes defining the AIE relatively to the image objects elements, b) a behaviour for modifying at least one of the attributes, c) at least one virtual sensor for gathering data information about at least one of the image object elements or other AIEs, and d) an AIE animation clips; the artificial intelligence agent including an autonomous image entity engine (AIEE) for updating each AIE's attributes and for triggering for each AIE at least one of a current behaviour and one of the at least one animation clip based on the current behaviour and the data information gathered by the at least one sensor.

According to a third aspect of the present invention, there is provided a system for on-screen animation of digital entities comprising:
means for providing a digital world including image object elements;
means for providing at least one autonomous image entity (AIE); each the AIE being associated with at least one AIE animation clip, and being characterized by a) attributes defining the at least one AIE relatively to the image objects elements, and b) at least one behaviour for modifying at least one of the attributes; the at least one AIE including at least one virtual sensor for gathering data information about at least one of the image object elements or other one of the at least one AIE;
means for initializing the attributes and selecting one of the behaviours for each of the at least one AIE;
means for using the at least one sensor to gather data information about at least one of the image object elements or other one of the each the at least one AIE;
means for using a decision tree for processing the data information;
means for triggering one of the at least one AIE animation clip according to the attributes and selected one of the at least one behaviour; and
means for selecting one of the at least one behaviour.

A method and system for animating digital entities according to the present invention can be used in applications where there is a need for seemingly reaction of characters and objects, for example:
In the special effects field for controlling or pre-visualizing, for example, motion of hundreds of rats running down a street or 10,000 soldiers fighting hand-to-hand;
in game development;
in 3D animation;
in cinematics (cut scenes);
in training systems. For example, the present invention would help implementing better automobile car driving training system with intelligent automobiles and pedestrians.

The method and system from the present invention provides software modules to create and control intelligent characters that can act and react to their worlds, such as:
intelligent navigation. Using dynamic path finding and collision avoidance, AI characters can smoothly move from point A to point B and avoid running into anything in their way;
intelligent animation control. Using animation blending, AI characters look natural by correctly choosing the correct animations, scales, and blends; and
interactivity. Using sophisticated sensor and decision-making systems, AI characters can learn about their worlds and respond to them accordingly from stopping at a stop sign to hunting down escaped prisoners;
The method and system for on-screen animation of digital entities provides the following advantages:
provide the means to create seemingly intelligent and sophisticated AI characters that act and react according to their changing environment;
provide sophisticated artificial intelligence techniques that may be too specialized or costly to develop in-house;
give the ability (time and tools) to refine content, which is all about fine-tuning. The method and system according to the present invention helps fine-tuning animation by allowing the AI to be up and running faster, and by providing real-time feed-back tools. Using a method and system for on-screen animation of digital entities from the present invention helps animators and designers to become independent from programmers.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

In the appended drawings:

FIG. 1 is a flowchart illustrating a method for on-screen animation of digital entities according to an illustrative embodiment of a first aspect the present invention;

FIG. 2 is a schematic view illustrating a two-dimensional barrier to be used with the method of FIG. 1;

FIG. 3 is a schematic view illustrating a three-dimensional barrier to be used with the method of FIG. 1;

FIG. 4 is a schematic view illustrating a co-ordinate system used with the method of FIG. 1;

FIG. 5 is a flowchart illustrating step 110 from FIG. 1 corresponding to the use of a decision tree to issue commands;

FIG. 6 is a bloc diagram of a system for on-screen animation of digital entities according to a first illustrative embodiment of a second aspect of the present invention;

FIG. 7 is a still image taken from a first example of animation created using the method from FIG. 1 and related to a representation of a school of fish and of a shark in a large aquarium;

FIG. 8 is a flowchart of a behaviour decision tree used in action selection for the animation illustrated in FIG. 7;

FIG. 9 is a behaviour decision tree to determine the behaviour of roman soldier in a second example of animation created using the method of FIG. 1 and related to a representation of a battle scene between roman soldiers and beast warriors;

FIG. 10 is a behaviour decision tree to determine the behaviour of beast warriors in the second example of animation created using the method of FIG. 1;

FIGS. 11A-11D are still images of a bird's eye view of the battle field from the second example of animation created using the method of FIG. 1, illustrating the march of the roman soldiers and beast warriors towards one-another;

FIG. 12 is a decision tree allowing to select the animation clip to trigger when a beast warrior and a roman soldier engage in battle in the second example of animation created using the method of FIG. 1;

FIGS. 13A-13C and 14 are still images taken from on-screen animation of the battle scene according to the second example of animation created using the method of FIG. 1; and

FIGS. 15 and 16 are bloc diagrams illustrating a system for on-screen animation of digital entities according to a second illustrative embodiment of a first aspect of the present invention.

### DETAILED DESCRIPTION OF THE INVENTION

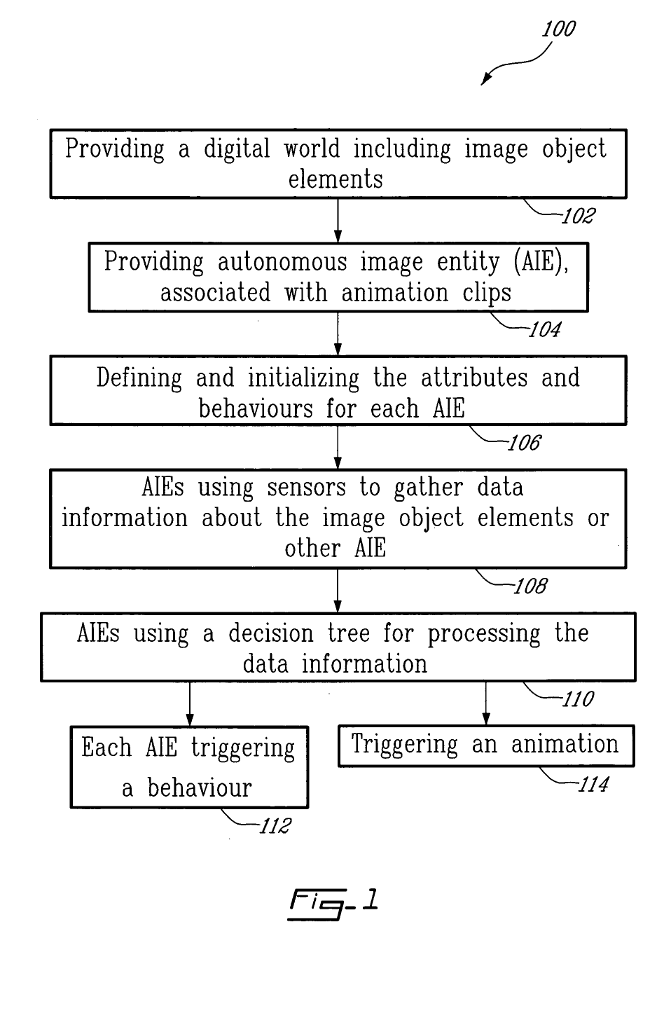

A method 100 for on-screen animation of digital entities according to an illustrative embodiment of a first aspect of the invention will now be described, with reference first to FIG. 1 of the appended drawings.

The method 100 comprises the following steps:
102—providing a digital world including image object elements;
104—providing autonomous image entity (AIE), associated with corresponding animation clips;
106—defining and initializing the attributes and behaviours for each AIE;
108—AIEs using sensors to gather data information about image object elements or other AI Es; and
110—AIEs processing the data information using decision trees, resulting in either:
112—each AIE triggering a behaviour; or
114—each AIE triggering an animation.

These general steps will now be further described.

A digital world model including image object elements is first provided in step 102. The image object elements include two or three-dimensional (2D or 3D) graphical representations of objects, autonomous and non-autonomous characters, building, animals, trees, etc. It also includes barriers, terrains, and surfaces. The concepts of autonomous and non-autonomous characters and objects will be described hereinabove in more detail.

As it is believed to be commonly known in the art, the graphical representation of objects and characters can be displayed, animated or not, on a computer screen or on another display device, but can also inhabit and interact in the virtual world without being displayed on the display device.

Barriers are triangular planes that can be used to build walls, moving doors, tunnels, etc. Terrains are 2D height-fields to which AIE can be automatically bound (e.g. keep soldier characters marching over a hill). Surfaces are triangular planes that may be combined to form fully 3D shapes to which autonomous characters can also be constrained.

In combination, these elements are to be used to describe the world in which the characters inhabit.

In addition to the image object elements, the digital world model includes a solver, which allows managing autonomous image entities (AIE), including autonomous characters, and other objects in the world.

The solver can have a 3D configuration, to provide the AIE with complete freedom of movement, or a 2D configuration, which is more computationally efficient, and allows an animator to insert a greater number of AIE in a scene without affecting performance of the animation system.

A 2D solver is computationally more efficient than a 3D solver since the solver does not consider the vertical (y) co-ordinate of an image object element or of an AIE. The choice between the 2D and 3D configuration depends on the movements that are allowed in the virtual world by the AIE and other objects. If they do not move in the vertical plane then there is no requirement to solve for in 3D and a 2D solver can be used. However, if the AIE requires complete freedom of movement, a 3D solver is used. It is to be noted that the choice of a 2D solver does not limit the dimensions of the virtual world, which may be 2D or 3D. The method 100 provides for the automatic creation of a 2D solver with default settings whenever an object or an AIE is created before a solver.

The following table shows examples of parameters that can be used to define the solver:

| Parameter | Description |
|---|---|
| Type | Can be either 2D or 3D. |
| Start Time | The start time of the solver. When the current |
| | time in the system embedding the solver is |
| | less than the Start Time, the solver does not |
| | update any AIE. |
| Width | The size of the world in the z direction. The |
| | width, depth, and height form the bounding box |
| | of the solver. Only the AIEs whose within −Width/2 |
| | and Width/2 from the solver centre are updated. |
| | The solver will not update AIEs outside this range. |
| Depth | The size of the world in the x direction. The |
| | width, depth, and height form the bounding box of |
| | the solver. Only the AIEs whose within −Depth/2 |
| | and Depth/2 from the solver centre are updated. |
| | The solver does not update AIEs outside this range. |
| Height | The size of the world in the y direction. The |
| | width, depth, and height form the bounding box of |
| | the solver. Only the AIEs whose within −Height/2 |
| | and Height/2 from the solver centre are updated. |
| | The solver will not update AIEs outside this range. |
| Grid Type | Can be either 2D or 3D. The grid is a |
| | space-partitioning grid used internally by the |
| | system to optimize the search for barriers. |
| | Increasing the number of partitions in the grid |
| | generally decreases the computational time needed |
| | to update the world, but increases the solver |
| | memory usage. A 2D grid can be used in a 3D world |
| | and is equivalent to using a 3D grid with 1 height |
| | partition. Such a parameter is relevant only when |
| | barriers are defined in the world as will |
| | be explained hereinbelow in more detail. |
| Grid Width | The number of partitions in the space-partitioning |
| Partitions | grid along the z-axis. This parameter is relevant |
| | only if barriers are defined in the world. The |
| | value is set greater than or equal to 1 and is |
| | also a power of 2, i.e. 1, 2, 4, 8, 16, 32, |
| | 64, 128, 256, 512, 1024, etc. |
| Grid Depth | The number of partitions in the space-partitioning |
| Partitions | grid along the x-axis. This parameter is relevant |
| | only if barriers are defined in the world. The |
| | value is set greater than or equal to 1 and is |
| | also a power of 2, i.e. 1, 2, 4, 8, 16, 32, |
| | 64, 128, 256, 512, 1024, etc. |
| Grid Height | The number of partitions in the space-partitioning |
| Partitions | grid along the y-axis. This parameter is relevant |
| | only if barriers are defined in the world. The |
| | value is set greater than or equal to 1 and is |
| | also a power of 2, i.e. 1, 2, 4, 8, 16, 32, |
| | 64, 128, 256, 512, 1024, etc. |
| Use Cache | This parameter allows to define whether or not a |
| | cache will be used. If a cache is activated, each |
| | frame that is computed is cached. When the |
| | animation platform requests the locations, |
| | orientations, and speeds of characters for a |
| | certain frame, the solver first searches for |
| | the information in the cache. If the solver does |
| | not find the required information, it calculates |
| | it. When a scene is saved, the cache is saved to |
| | the cache file. When a scene is loaded, the |
| | cache is loaded from the cache file. |
| Center Position | The centre of the solver's bounding box given as |
| | x, y, z co-ordinates. |
| Random Seed | The random seed allows generating a sequence of |
| | pseudo-random numbers. The same seed will result |
| | in the same sequence of generated random numbers. |
| | Random numbers are used for wander behaviours, |
| | behaviours with probabilities, and random sensors |
| | as will be explained hereinbelow. For example, if |
| | an AIE has a Wander Around behaviour, using the |
| | same seed, the Wander Around behaviour will produce |
| | the same random motions each time the scene is |
| | played and the AIE will move in the exact same way |
| | each time if no AIE are added to the scene. By |
| | changing the random seed, the Wander Around |
| | behaviour will generate a new sequence of random |
| | motions and the character will move differently |
| | than before. |

Non-autonomous characters are objects in the digital world that, even though they may potentially interact with the digital world, are not driven by the solver. These can range from traditionally animated characters (e.g. the leader of a group) to objects (e.g. boulders and trees) driven by the solver.

Barriers are equivalent to one-way walls, i.e. an object or an AIE inhabiting the digital world can pass through them in one direction but not in the other. When a barrier is created, spikes (forward orientation vectors) are used to indicate the side of the wall that can be detected by an object or an AIE. Therefore, an object or an AIE can pass from the non-spiked side to the spiked side, but not vice-versa. It is to be noted that a specific behaviour must be defined and activated for an AIE to attempt to avoid the barriers in the digital world (Avoid Barriers behaviour). The concept of behaviours will be described hereinbelow in more detail.

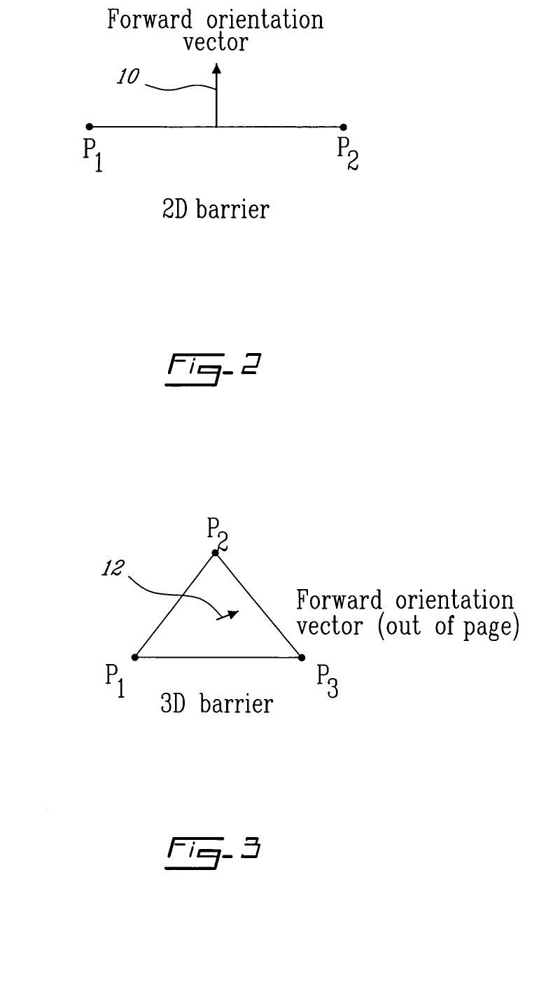

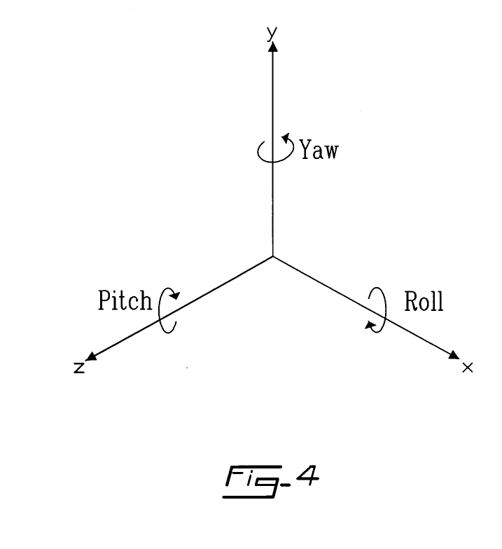

As illustrated in FIGS. 2 and 3 respectively, a barrier is represented in a 2D solver by a line and by a triangle in a 3D solver. The direction of the spike for 2D and 3D barriers is also shown in FIGS. 2-3 (see arrows 10 and 12 respectively) where P1-P3 refers to the order in which the points of the barrier are drawn. Since barriers are unidirectional, two-sided barriers are made by superimposing two barriers and by setting their spikes opposite to each other.

Each barrier can be defined by the following parameters:

| Parameter | Description |
|---|---|
| Exists | This parameter allows the system to determine whether |
| | or not the barrier exists in the solver world. If |
| | this is set to off the solver ignores the barrier. |
| Collidable | This parameter allows the system to determine whether |
| | or not collisions with other collidable objects will |
| | be resolved. If this parameter is set to off |
| | characters can pass through the barrier |
| | from either side. |
| Opaque | This parameter allows set whether or not objects can |
| | see through the barrier using a sensor as will be |
| | explained hereinbelow. |
| Surface | This parameter allows set whether or not the barrier |
| | will be considered as a surface. A barrier that is a |
| | surface is considered for surface hugging by the solver. |
| Use | This parameter allows the system to determine whether |
| Bounding | or not to create barriers based on the bounding boxes |
| Box | for the selected objects. If the currently active |
| | solver has a 2D configuration then the barriers |
| | created with this option will only be created around |
| | the bounding-perimeter. If the solver is 3D, then |
| | barriers will be created and positioned the same way |
| | as the bounding box for the object. |
| Use | If the “Use Bounding Box ”parameter is enabled |
| Bounding | and this option is also enabled a barrier-bounding |
| Box Per | box per selected object will be created. If it is |
| Object | disabled, a barrier-bounding box will be created at |
| | the bounding box for the group of selected items. |
| Reverse | This parameter reverses the normals for the selected |
| Barrier | barriers. |
| Normal | |
| Group | When this parameter is activated, all barriers are |
| Barriers | grouped under a group node. |

As it is commonly known, a bounding box is a rectilinear box that encapsulates and bounds a 3D object.

When barriers are defined in the world, the space-partitioning grid in the AI solver may be specified in order to optimize the solver calculations that concern barriers.

The space-partitioning grid allows to optimize the computational time needed for solving, including updating each AIE state (steps 108-114) as will be described hereinbelow in more detail. More specifically, the space-partitioning grid allows optimizing the search for barriers that is necessary when an Avoid Barriers behaviour is activated and is also used by the surface-hugging and collision subsolvers, which will be described hereinbelow.

Increasing the number of partitions in the grid generally decreases the computational time needed to update the world, but increases the solver memory usage. The space-partitioning grid is defined via the Grid parameters of the AI solver. The number of partitions along each axis may be specified which effectively divides the world into a given number of cells. Choosing suitable values for these parameters allows tuning the performance. However, values that are too large or too small can have a negative impact on performance. Cell size should be chosen based on average barrier size and density and should be such that, on average, each cell holds about 4 or 5 barriers.

The solver of the digital world model includes subsolvers, which are the various engines of the solver that are used to run the simulation. Each subsolver manages a particular aspect of object and AIE simulation in order to optimize computations.

After the digital world has been set, autonomous image entities (AIE) are defined in step 104. Each AIE may represent a character or an object that is characterized by attributes defining the AIE relatively to the image objects elements of the digital world, and behaviours for modifying some of the attributes. Each AIE is associated to animation clips allowing representing the AIE in movement in the digital world. Virtual sensors allow the AIE to gather data information about image object elements or other AIE within the digital world. Decision trees are used for processing the data information resulting in selecting and triggering one of the animation cycle or selecting a new behaviour.

As it is believed to be well known in the art, an animation cycle, which will also be referred to herein as “animation clip” is a unit of animation that typically can be repeated. For example, in order to get a character to walk, the animator creates a “walk cycle”. This walk cycle makes the character walks one iteration. In order to have the character walk more, more iterations of the cycle are played. If the character speeds up or slows down during time, the cycle is “scaled” accordingly so that the cycle speed matches the character displacement so that there is no slippage (e.g., it looks like the character is slipping on the ground).

The autonomous image entities are tied to transform nodes of the animating engine (or platform). The nodes can be in the form of locators, cubes or models of animals, vehicles, etc. Since animation clips and transform nodes are believed to be well known in the art, they will not be described herein in more detail.

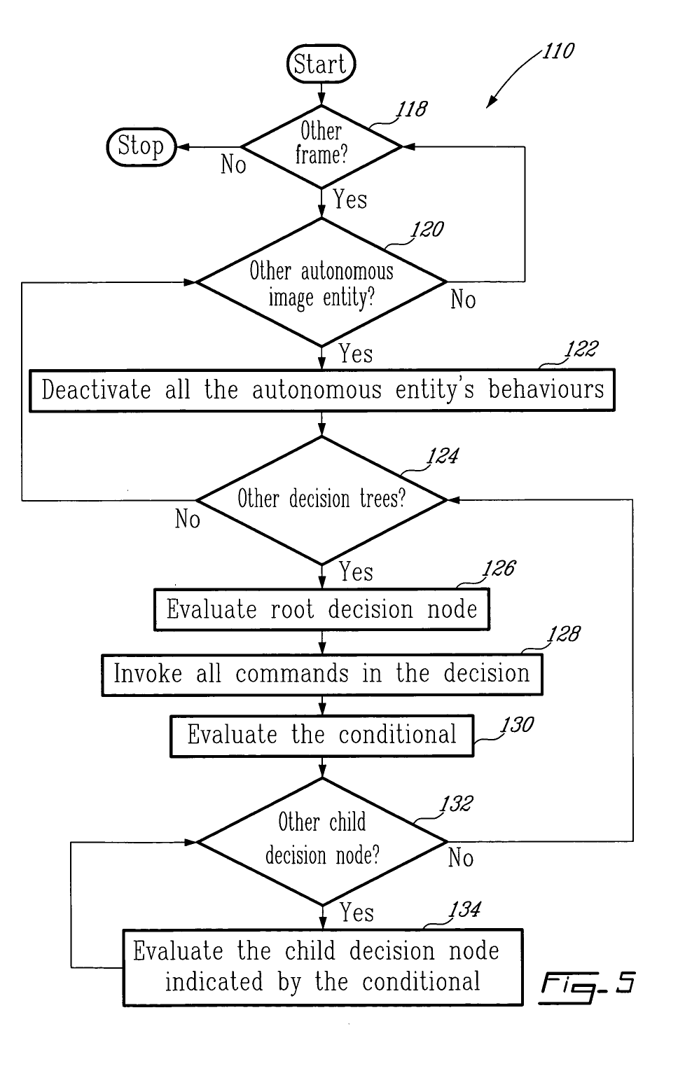

FIG. 4 shows a co-ordinate system for the AIE and used by the solver.

Examples of an AIE attributes are briefly described in the following tables. Even though, this table refers to characters, the listed attributes apply to all AIE.

| Attribute | Description |
|---|---|
| Exists | This attribute allows the solver whether or not to |
| | consider the AIE in the world. If this attribute it |
| | is set to off, the solver ignores the AIE and does |
| | not update it. This attribute allows |
| | dynamically creating and killing characters (AIEs). |
| Hug | This attribute allows setting whether or not the AIE |
| Terrain | will hug the terrain. If this is set to on the AIE |
| | will remain on the terrain. It is to be noted that |
| | terrains are activated only when the solver is in |
| | 2D mode. |
| Align | This attribute allows setting whether or not the AIE |
| Terrain | will align with the terrain's surface normal. This |
| Normal | parameter is taken into account when the AIE is |
| | hugging the terrain. |
| Terrain | This attribute specifies an extra height that will |
| Offset | be given to a character when it is on a terrain. |
| | The offset is only taken into account when the AIE |
| | is hugging the terrain. A positive value causes the |
| | AIE to float above the terrain, and a negative value |
| | causes the AIE to be sunken into the terrain. |
| Hug | This attribute specifies whether or not the AIE |
| Surface | will hug a surface. A surface is a barrier with the |
| | Surface attribute set to true. Surface hugging |
| | applies in a 3D solver. The AIE hugs the |
| | nearest surface below it. |
| Align | This attribute specifies whether or not the AIE's |
| Surface | up orientation aligns to the surface normal. This |
| Normal | parameter is taken into account when the AIE is on |
| | a surface. An AIE with both hug surface and align |
| | surface enabled will follow a 3D surface defined by |
| | barriers, while aligning the up of the AIE according |
| | to the surface. |
| Surface | This attribute specifies an extra height that will |
| Offset | be given to an AIE when it is on a surface. The |
| | offset is taken into account only when the AIE is |
| | hugging a surface. A positive value will cause the |
| | AIE to float above the surface, and a negative value |
| | will cause the AIE to be sunken into the surface. |
| Collidable | This attribute specifies whether or not collisions |
| | with other collidable objects will be resolved. If |
| | this parameter is set to false then nothing will |
| | prevent the AIE from occupying the same space as |
| | other objects, as would (for instance) a ghost. |
| Radius | This attribute specifies the radius of the AIE's |
| | bounding sphere. Since the concept of bounding |
| | sphere is believed to be well known in the art, it |
| | will not be described herein in more detail. |
| Right | This attribute specifies the maximum right turning |
| Turning | angle (clockwise yaw) per frame measured in degrees. |
| Radius | The angle can range from 0-180 degrees. |
| Left | This attribute specifies the maximum left turning |
| Turning | angle (anticlockwise yaw) per frame measured in |
| Radius | degrees. The angle can range from 0-180 degrees. |
| Up | This attribute specifies the maximum up turning |
| Turning | angle (positive pitch) per frame measured in |
| Radius | degrees. The angle can range from 0-180 degrees. |
| Down | This attribute specifies the maximum down turning |
| Turning | angle (negative pitch) per frame measured in |
| Radius | degrees. The angle can range from 0-180 degrees. |
| Maximum | This attribute specifies the maximum positive |
| Angular | change in angular speed of the AIE, measured in |
| Acceler- | degrees/frame². If this variable is larger than |
| ation | the turning radii, it will have no effect. If |
| | set smaller than the turning radii, it will |
| | increase the AIE's resistance to angular change. |
| | In general, the maximum angular acceleration should |
| | be set smaller than the maximum angular deceleration |
| | to avoid overshoot and oscillation effects. |
| Maximum | This attribute specifies the maximum negative |
| Angular | change in angular speed of the character, measured |
| Deceler- | in degrees/frame². If this variable is larger than |
| ation | the turning radii, it will have no effect. If set |
| | smaller than the turning radii, it will increase the |
| | AIE's resistance to angular change. In general, the |
| | maximum angular acceleration should be set smaller |
| | than the maximum angular deceleration to avoid |
| | overshoot and oscillation effects. |
| Maximum | This attribute specifies the maximum angle of |
| Pitch | deviation from the z-axis that the object's top |
| (a.k.a. | vector may have, measured in degrees. The maximum |
| Max | pitch can range from −180 to 180 degrees. This |
| Stability | attribute can be used to limit how steep a hill the |
| Angle) | AIE can climb or descend to prevent objects from |
| | incorrectly turning upside down. |
| Maximum | This attribute specifies the maximum angle of |
| Roll | deviation from the x-axis that the object's top |
| | vector may have, measured in degrees. The maximum |
| | can roll range from −180 to 180 degrees. This |
| | attribute can be used to limit the side-to-side |
| | tilting of the AIE to prevent objects from |
| | incorrectly turning upside down. |
| Min | This attribute specifies the minimum speed (distance |
| Speed | units/frame) of the AIE. |
| Max | This attribute specifies the maximum speed (distance |
| Speed | units/frame) of the AIE. |
| Max | This attribute specifies the maximum positive |
| Acceler- | change in speed (distance units/frame²) of the AIE. |
| ation | |
| Max | This attribute specifies the maximum negative |
| Deceler- | change in speed (distance units/frame²) of the AIE. |
| ation | |
| Brake | Braking is only applied when an AIE tries to turn |
| Padding | at an angle greater than one of its turning radii. |
| and | When this occurs, the Brake Padding and Braking |
| Braking | Softness parameters work together to slow the AIE |
| Softness | down so that it doesn't overshoot the turn. |
| | Brake Padding controls when braking is applied. It |
| | can be set to 0, which means that braking will be |
| | applied as soon as the object tries to turn beyond |
| | one of its maximum turning radii, or 1 which means |
| | that braking is never applied. Values between 0 |
| | and 1 interpolate those extremes. The default |
| | value is 0. |
| | Braking softness controls the gentleness of braking |
| | and can be set to any positive number, including zero. |
| | A value of 0 corresponds to maximum braking strength |
| | and the AIE will come to a complete stop as soon as |
| | the brakes are applied. A value of 1 corresponds to |
| | normal strength, and values greater than 1 result |
| | in progressively gentler braking. The default value |
| | is 1. |
| | Setting a very large Braking Softness |
| | (effectively + ∞) is equivalent to setting |
| | the Brake Padding to 1, which is equivalent to |
| | turning braking off. |
| Forward | This attribute is set to on to limit the movement |
| Motion | of the AIE such that it may only move in the |
| Only | direction it is facing. Off will allow the AIE to |
| | move and face in different directions, provided that |
| | its behaviours are set up to produce such motion. |
| | The default value is on. |
| Initial | This attribute specifies the initial speed of the |
| Speed | AIE (distance units/frame) at start time. |
| Initial | This attribute specifies the initial position of |
| Position | the AIE at start time. The default is the position |
| X, Y, Z | where the object was created. |
| Initial | This attribute specifies the initial orientation of |
| Orientation | the AIE at start time. The default is the orientation |
| X, Y, Z | of the object when created. |
| Display | This attribute specifies whether or not the radius |
| Radius | and heading of the AIE will be displayed. |
| Current | This attribute specifies the current speed (distance |
| Speed | units/frame) of the AIE. The solver controls this |
| | variable. |
| Translate | This attribute specifies the current position of |
| | the AIE. The AI solver controls this variable. |
| Rotate | This attribute specifies the current orientation |
| | of the AIE. The solver controls this variable. |

Of course, other attributes can also be used to characterize an AIE.

In step 106, each AIE attributes are initialized and an initial behaviour among the set of behaviours defined for each AIE is assigned thereto. The initialisation of attributes may concern only selected attributes, such as the initial position of the AIE, its initial speed, etc. As described in the above table, some attributes are modifiable by the solver or by a user via a user interface or a keyable command, for example when the method 100 is embodied in a computer game.

The concept of AIE behaviour will now be described hereinbelow in more detail.

In addition to attributes, AIE from the present invention are also characterized by behaviours. Along with the decision trees, the behaviours are the low-level thinking apparatus of an AIE. They take raw input from the digital world using virtual sensors, process it, and change the AIE's condition accordingly.

Behaviours can be categorized, for example, as State Change behaviours and Locomotive behaviours. State change behaviours modify a character's internal state attributes, which represent for example the AIE's “health”, or “aggressivity”, or any other non-apparent characteristics of the AIE. Locomotive behaviours allow an AIE to move. These locomotive behaviours generate steering forces that can affect any or all of an AIE's direction of motion, speed, and orientation (i.e. which way the AIE is facing) for example.

The following table includes examples of behaviours:

| Simple behaviours: | Targeted behaviours: |
|---|---|
| Avoid Barriers | Seek To |
| Avoid Obstacles | Flee From |
| Accelerate At | Look At |
| Maintain Speed At | Follow Path |
| Wander Around | Seek To Via Network |
| Orient To | |

| Group behaviours: | State Change behaviours: |
|---|---|
| Align With | State Change On Proximity |
| Join With | Target State Change On Proximity |
| Separate From | |
| Flock With | |

A locomotive behaviour can be seen as a force that acts on the AIE. This force is a behavioural force, and is analogous to a physical force (such as gravity), with a difference that the force seems to come from within the AIE itself.

It is to be noted that behavioural forces can be additive. For example, an autonomous character may simultaneously have more then one active behaviours. The solver calculates the resulting motion of the character by combining the component behavioural forces, in accordance with behaviour's priority and intensity. The resultant behavioural force is then applied to the character, which may impose its own limits and constraints (specified by the character's turning radius attributes, etc) on the final motion.

The following table briefly describes examples of parameters that can be used to define behaviours:

| Parameter | Description |
|---|---|
| Active | This parameter defines whether or not the behaviour |
| | is active. If the behaviour is not active it will be |
| | ignored by the solver and will have no effect on the AIE. |
| Intensity | The higher the intensity, the stronger the behavioural |
| | steering force. The lower the intensity (or the closer |
| | to 0), the weaker the behavioural steering force. For |
| | example, an intensity of 1 causes the behaviour to |
| | operate at “full strength”, an intensity of 2 |
| | causes the behaviour to produce twice the steering |
| | force, and an intensity of 0 effectively turns |
| | the behaviour off. |
| Priority | The priority of a behaviour defines the precedence |
| | it will take over other behaviours. Behaviours of |
| | higher priority (i.e. those with a lower numerical |
| | value) take precedence over behaviours of lower |
| | priority. Therefore, if a behaviour of higher |
| | priority produces a desired motion, then a behaviour |
| | of lower priority is ignored. A priority of 0 is |
| | considered the highest priority (i.e. of most |
| | importance). |
| | For example, a character has a Flee |
| | From behaviour with priority 0 and a Follow Path |
| | behaviour with priority 1. If the Flee From behaviour |
| | produces a desired motion, then the Follow Path |
| | behaviour is ignored. However, if the Flee From |
| | Behaviour does not produce a desired motion, |
| | such as when it is inactive or the target is outside |
| | the activation radius, the Follow Path behaviour |
| | is taken into account. |
| Blend Time | This parameter allows controlling the transition time, |
| | expressed as number of frames, that a behaviour will |
| | take to change from an active to inactive state or |
| | vice-versa. For example, a blend time of zero means |
| | that a behaviour can change its state instantaneously. |
| | In other words the behaviour could be inactive one |
| | frame and at full-force the next. Increasing the blend |
| | time will allow behaviours to fade in and out, thus |
| | creating smoother transitions between behaviour |
| | effects. However, this will also increase the time |
| | required for an AIE to respond to stimuli provided |
| | by one of the AIE's sensor as will be described |
| | hereinbelow in more detail. |
| Affects | This parameter indicates whether the behavioural force |
| Speed | produced by this behaviour may affect the speed of a |
| | moving AIE. This parameter is set to on by default. |
| | If a speed force is produced by the behaviour, |
| | behaviours of a lower priority are prevented from |
| | affecting the speed of the AIE. |
| Affects | This parameter indicates whether the behavioural force |
| Direction | produced by this behaviour may affect the direction |
| | of motion of an AIE. By default this parameter is set |
| | to on. If a directional force is produced by the |
| | behaviour, behaviours of a lower priority are prevented |
| | from affecting the direction of the AIE. |
| Affects | This parameter indicates whether the behavioural force |
| Orientation | produced by this behaviour may affect the orientation |
| | of an AIE (which way the AIE is facing, as opposed to |
| | its direction of motion). By default this parameter |
| | is set to on. If an orientation force is produced by |
| | the behaviour, behaviours of a lower priority are |
| | prevented from affecting the orientation of the AIE. |

The behaviours allow creating a wide variety of actions for AIEs. Behaviours can be divided into four subgroups: simple behaviours, targeted behaviours, group behaviours and state change behaviours.

Simple behaviours are behaviours that only involve a single AIE.

Targeted behaviours apply to an AIE and a target object, which can be any other object in the digital world (including groups of objects).

Group behaviours allow AIEs to act and move as a group where the individual AIEs included in the group will maintain approximately the same speed and orientation as each other.

State change behaviours enable the state of an object to be changed.

Examples of behaviours will now be provided in each of the four categories. Of course, it is believed to be within a person skilled in the art to provide an AIE with other behaviours.

Simple Behaviours

Avoid Barriers

The Avoid Barriers behaviour allows a character to avoid colliding with barriers. When barriers are defined in the world, the space-partitioning grid in the AI solver may be specified in order to optimize the solver calculations that concern barriers.

Parameters specific to this behaviour may include, for example:

| Parameter | Description |
|---|---|
| Avoid | The distance from a barrier at which the AIE will |
| Distance | attempt to avoid it. This is effectively the distance |
| | at which barriers are visible to the AIE. |
| Avoid | Whether or not the avoidance distance is adjusted |
| Distance | according to the AIE's speed. If this is set to on, |
| Is Speed | the faster the AIE moves, the greater the avoidance |
| Adjusted | distance. |
| Avoid | The avoidance width factor defines how wide the |
| Width | “avoidance capsule” is (the length of the |
| Factor | “avoidance capsule” is equal to the Avoid |
| | Distance). If a barrier lies within the avoidance |
| | capsule, the AIE will take evasive action. The value |
| | of the avoidance width factor is multiplied by the |
| | AIE's width in order to determine the true width (and |
| | height in a 3D solver) of the capsule. A value of 1 |
| | sets the capsule to the same width as the AIE's diameter. |
| Barrier | Allows controlling how much the AIE is pushed away |
| Repulsion | from barriers. A value of 0 indicates no repulsion and |
| Force | the AIE will tend to move parallel to nearby barriers. |
| | Larger values will add a component of repulsion based |
| | on the AIE's incident angle. |
| Avoidance | Allows controlling the AIE's barrier avoidance strategy. |
| Queuing | If set to on the AIE will slow down when approaching a |
| | barrier, if set to off the AIE will dodge the barrier. |
| | The default value is off. |

The Avoid Obstacles behaviour allows an AIE to avoid colliding with obstacles, which can be other autonomous and non-autonomous image entities. Similar parameters than those detailed for the Avoid Barriers behaviour can also be used to define this behaviour.

Accelerate At

The Accelerate At behaviour attempts to accelerate the AIE by the specified amount. For example, if the amount is a negative value, the AIE will decelerate by the specified amount. The actual acceleration/deceleration may be limited by max acceleration and max deceleration attributes of the AIE.

A parameter specific to this behaviour is the Acceleration, which represents the change in speed (distance units/frame2) that the AIE will attempt to maintain.

Maintain Speed At

The Maintain Speed At behaviour attempts to set the target AIE's speed to a specified value. This can be used to keep a character at rest or moving at a constant speed. If the desired speed is greater than the character's maximum speed attribute, then this behaviour will only attempt to maintain the character's speed equal to its maximum speed. Similarly, if the desired speed is less than the character's minimum speed attribute, this behaviour will attempt to maintain the character's speed equal to its minimum speed.

A parameter allowing defining this behaviour is the desired speed (distance units/frame) that the character will attempt to maintain.

Wander Around

The Wander Around behaviour applies random steering forces to the AIE to ensure that it moves in a random fashion within the solver area.

Parameters allowing to define this behaviour may be for example:

| Parameter | Description |
|---|---|
| Is Persistent | This parameter allows defining whether or not the |
| | desired motion calculated by this behaviour is |
| | applied continuously (at every frame) or only when |
| | the desired motion changes (see the Probability |
| | attribute). A persistent Wander Around behaviour |
| | produces the effect of following random waypoints. |
| | A non-persistent Wander Around behaviour causes the |
| | AIE to slightly change its direction and/or speed |
| | when the desired motion changes. |
| Probability | This parameter allows defining the probability that |
| | the direction and/or speed of wandering will change |
| | at any time frame. For example, a value of 1 means |
| | that it will change each time frame, a value of 0 |
| | means that it will never change. On average, the |
| | desired motion produced by this behaviour will |
| | change once every 1/probability frames (i.e. average |
| | frequency = 1/probability) |
| Max Left Turn | This parameter allows defining the maximum left |
| | wandering turn angle in degrees at any time frame. |
| Max Right Turn | This parameter allows defining the maximum right |
| | wandering turn angle in degrees at any time frame. |
| Left Right Turn | This parameter affects the value of the pseudo-random |
| Radii Noise | left and right turn radii generated by this behaviour. |
| Frequency | A valid range can be between 0 and 1. The higher the |
| | frequency the more frequent an AIE will change |
| | direction. The lower the frequency the less often an |
| | AIE will change direction. |
| Max Up Turn | This parameter allows defining the maximum up |
| | wandering turn angle in degrees at any time frame. |
| Max Down Turn | This parameter allows defining the maximum down |
| | wandering turn angle in degrees at any time frame. |
| Up Down Turn | This parameter affects the value of the pseudo-random |
| Radii Noise | up and down turn radii generated by this behaviour. |
| Frequency | The valid range is between 0 and 1. The higher the |
| | frequency the more frequent an AIE will change |
| | direction. The lower the frequency the less often an |
| | AIE will change direction. |
| Max | This parameter allows defining the maximum wander |
| Deceleration | deceleration (distance units/frame²) at any time frame. |
| Max | This parameter allows defining the maximum wander |
| Acceleration | acceleration (distance units/frame²) at any time frame. |
| Speed Noise | This parameter affects the value of the pseudo-random |
| Frequency | speed generated by this behaviour. The valid range is |
| | between 0 and 1. The higher the frequency the more |
| | frequent an AIE will change direction. The lower the |
| | frequency the less often an AIE will change direction. |
| Min Speed | This parameter allows defining the minimum speed |
| | (distance units/frame) that the behaviour will |
| | attempt to maintain. |
| Use Min Speed | This parameter allows defining whether or not the |
| | Min Speed attribute will be used. |
| Max Speed | This parameter allows defining the maximum speed |
| | (distance units/frame) that the behaviour will attempt |
| | to maintain. |
| Use Max | This parameter allows defining whether or not the |
| Speed | Max Speed attribute will be used. |

Orient To

The Orient To behaviour allows an AIE to attempt to face a specific direction.

Parameters allowing to define this behaviour are:

| Parameter | Description |
|---|---|
| Desired | This parameter allows defining the direction this |
| Forward | AIE will attempt to face. For example, a desired |
| Orientation | forward orientation of (1, 0, 0) will make an AIE |
| | attempt to align itself with the x-axis. When a 2D |
| | solver is used, the y component of the desired forward |
| | orientation is ignored. |
| Relative | If true, then the desired forward orientation attribute |
| | is interpreted to be relative to the current character |
| | forward. If false, then the desired forward is in |
| | absolute world coordinates. By default, this value is |
| | set to false. |

Targeted Behaviours

The following behaviours apply to an AIE (the source) and another object in the world (the target). Target objects can be any object in the world such as autonomous or non-autonomous image entities, paths, groups and data. If the target is a group, then the behaviour applies only to the nearest member of the group at any one time. If the target is a datum, then it is assumed that this datum is of type ID and points to the true target of the behaviour. An ID is a value used to uniquely identify objects in the world. The concept of datum will be described in more detail hereinbelow.

The following parameters, shared by all targeted behaviours, are:

| Parameter | Description |
|---|---|
| Activation | The Activation Radius determines at what point the |
| Radius | behaviour is triggered. The behaviour will only be |
| | activated and the AIE will only actively seek a |
| | target if the AIE is within the activation radius |
| | distance from the target. A negative value for the |
| | activation radius indicates that there is no |
| | activation radius, or that the feature is not |
| | being used. This means that the behaviour will always |
| | be on regardless of the distance between the AIE and |
| | the target. |
| Use | This parameter allows defining whether or not the |
| Activation | Activation Radius feature will be used. If this is |
| Radius | off, the behaviour will always be activated regardless |
| | of the location of the AIE. |

Seek To

The Seek To behaviour allows an AIE to move towards another AIE or towards a group of AIEs. If an AIE seeks a group, it will seek the nearest member of the group at any time.

Parameters allowing to define this behaviour are for example:

| Attribute | Description |
|---|---|
| Look | This parameter instructs the AIE to move towards a |
| Ahead | projected future point of the object being sought. |
| Time | Increasing the amount of look-ahead time does not |
| | necessarily make the Seek To behaviour any |
| | “smarter” since it simply makes a linear |
| | interpolation based on the target's current speed and |
| | position. Using this parameter gives the |
| | behaviour sometimes referred to as “Pursuit”. |
| Offset | This parameter allows specifying an offset from the |
| radius | target's centre point that the AIE will actually |
| | seek towards. |
| Offset | This parameter allows defining the angle in degrees |
| Yaw | about the front of the target in the yaw direction |
| Angle | that the offset is calculated. The angle describes the |
| | amount of counter-clockwise rotation about the |
| | front of the target. For example, to make a soldier |
| | follow a leader, the soldier seek the leader with a |
| | positive offset radius and an offset yaw angle of |
| | 180°. |
| | This attribute is ignored if the Strafing |
| | parameter is turned on. Strafing automatically sets |
| | an appropriate value for the offset angle. |
| Offset | This parameter is the similar to Offset Yaw Angle but |
| Pitch | for the offset angle in the pitch direction relative |
| Angle | to the target object's orientation. This applies only |
| | in the case of a 3D solver and will be ignored in a |
| | 2D solver. |
| Contact | This parameter allows specifying a proximity radius |
| Radius | at which point the behaviour is triggered. In other |
| | words, it defines the point at which the AIE has |
| | reached the target and has no reason to continue |
| | seeking it. If the parameter is set to −1, this |
| | feature is turned off and the AIE will always attempt |
| | to seek the target regardless of their relative |
| | positions. Since the contact radius extends the |
| | target's radius, a value of 0 means that the AIE will |
| | stop seeking when it touches (or intersects with) |
| | the target. |
| Use | This parameter allows defining whether or not the |
| Contact | Contact Radius feature is used. If this is off, the |
| Radius | AIE will always attempt to seek the target regardless |
| | of their relative positions |
| Slowing | The slowing radius specifies the point at which the |
| Radius | AIE begins to attempt to slow down and arrive at a |
| | standstill at the contact radius (or earlier). If set |
| | to −1, this feature is turned off and the AIE will |
| | never attempt to stop moving when it reaches its target. |
| | This feature of Seek To is sometimes referred to as |
| | ″Arrival″. It is to be noted that the slowing |
| | radius is taken to be the distance from the contact |
| | radius, which itself is the distance from the external |
| | radius of the target. |
| Use | This parameter allows defining whether or not the |
| Slowing | Slowing Radius feature is used. If this is off, the AIE |
| Radius | will not attempt to slow down when reaching the target. |
| Desired | The desired speed instructs an AIE to move towards |
| Speed | the target at the specified speed. If this is set to a |
| | negative number or Use Desired Speed is off, this |
| | feature is turned off and the AIE will attempt to |
| | approach the target at its maximum speed. |
| Use | This parameter allows defining whether or not the |
| Desired | Desired Speed attribute will be used. If this is off, |
| Speed | the AIE will attempt to approach the target at its |
| | maximum speed. |

Flee From

The Flee From behaviour allows an AIE to flee from another AIE or from a group of AIEs. When an AIE flees from a group, it will flee from the nearest member of the group at any time. The Flee From behaviour has the same attributes as the Seek To behaviour, however, it produces the opposite steering force. Since the parameters allowing defining the Flee From behaviour are very similar to those of the Seek To behaviour, they will not be described herein in more detail.

Look At

The Look At behaviour allows an AIE to face another AIE or a group of AIEs. If the target of the behaviour is a group, the AIE attempts to look at the nearest member of the group.

Strafe

The Strafe behaviour causes the AIE to “orbit” its target, in other words to move in a direction perpendicular to its line of sight to the target. A probability parameter allows to determine how likely it is at each frame that the AIE will turn around and start orbiting in the other direction. This can be used, for instance, to make a moth orbit a flame.

For example, the effect of a guard walking sideways while looking or shooting at its target can be achieved by turning off the guard's Forward Motion Only property, and adding a Look At behaviour set towards the guard's target. It is to be noted that, to do this, Strafe is set to Affects direction only, whereas Look At is set to Affects orientation only.

A parameter specific to this behaviour may be, for example, the Probability, which may take a value between 0 and 1 that determines how often the AIE change direction of orbit. For example, at 24 frames per second, a value of 0.04 will trigger a random direction change on average every second, whereas a value of 0.01 will trigger a change on average every four seconds.

Go Between

The Go Between behaviour allows an AIE to get in-between the first target and a second target. For example this behaviour can be used to enable a bodyguard character to protect a character from a group of enemies.

The following parameter allow specifying this behaviour, which may take a value between 0 and 1 that determines how close to the second target you want to go.

Follow Path

The Follow Path behaviour allows an AIE to follow a path. For example this behaviour can be used to enable a racecar to move around a racetrack.

The following parameters allow defining this behaviour:

| Parameter | Description |
|---|---|
| Use Speed | This parameter allows defining whether or not the AIE |
| Limits | will attempt to use the speed limits of the waypoints |
| | on the path. If this parameter is set to off, the AIE |
| | will attempt to follow the path at its maximum speed. |
| Path Is | This parameter allows defining whether or not the AIE |
| Looped | will go to the first waypoint when it reaches the last |
| | waypoint. If the parameter is set to off, when the AIE |
| | reaches the last waypoint it will hover around that |
| | waypoint. |

Seek To Via Network

The Seek To Via Network behaviour can be viewed as an extension of the Seek To behaviour that allows a source (AIE) to use a waypoint network to navigate towards a target. The purpose of a waypoint network is to store as much pre-calculated information as possible about the world that surrounds the character and, in particular, the position of static obstacles. The waypoint network, which will be described hereinbelow in more detail, can be used for example in one of two ways:

Edges in the network are used to define a set of “safe corridors” within which a source object can safely navigate without fear of running into a barrier or other static obstacles. Thus, once an AIE has reached a corridor in the network, it can safely navigate from waypoint to waypoint via the network.

While navigating, periodic reach ability tests are performed in order to determine whether it is safe to cut corners thus producing more natural motion. The frequency of these tests can be adjusted using the behaviour parameters.

In addition to the parameters that are available for the Seek To behaviour, the Seek To Via Network behaviour has the following additional parameters that can be used to control the type and frequency of the vision tests used:

| Paramter | Description |
|---|---|
| Period For | This parameter allows determining how often the AIE's |
| Current | current location is checked. This is to catch |
| Location Check | situations where an AIE is suddenly transported to |
| | another section of the world, e.g. via a teleport or by |
| | falling off a cliff. Default value = 1. To disable |
| | this check, set value to 0. |
| Period For | This parameter allows determining how often the |
| Target | target's location is checked. This is to handle |
| Location Check | the case of a dynamic (moving) target. Default |
| | value = 1. To disable this check, set value to 0. |
| Period For | This parameter allows determining how often the desired |
| Path | path of the AIE is adjusted to provide |
| Smoothing | “smoother” motion. This is equivalent to looking |
| Check | ahead and checking for shortcuts between the AIE's |
| | current location and a future waypoint on the |
| | character's desired path. This check is omitted when |
| | the vision test to use is set to “Simple”. The default |
| | value is set 1. To disable this check, set value to 0. |
| Barrier | The barrier-padding factor is multiplied by an AIE's |
| Padding Factor | radius to determine the minimum clearance distance |
| | to be used when deciding if an AIE can move around a |
| | barrier safely. This value is not used when the vision |
| | test to use is set to “Simple”. The default |
| | value = 1.0. |

It is to be noted that the Seek To parameters are used to guide the motion of the AIE, however the contact radius and slowing radius parameters are only used when the AIE seeks its final target. In addition, when the AIE seeks its final target, only checks for barrier avoidance are performed rather than checks for current location, target location, and path smoothing. This single check is performed at each call to this behaviour.

Group Behaviours

Group behaviours allow grouping individual AIEs so that they act as a group while still maintaining individuality. Examples include a school of fish, a flock of birds, etc.

The following parameters may be used to define group behaviours:

| Parameter | Description |
|---|---|
| Neighbourhood | This parameter is similar to the ″activation radius″ |
| Radius | in targeted behaviours. The AIE will “see” only |
| | those members that are within its neighbourhood radius. |
| | The neighbourhood radius is independent of the AIE's |
| | radius. |
| Use Max | This parameter allows defining whether or not the Max |
| Neighbours | Neighbours attribute will be used. If this parameter |
| | is set to off, then all the group members in the |
| | neighbourhood radius are used to calculate the effect |
| | of the behaviour. |
| Max | This parameter allows defining the maximum number of |
| Neighbours | neighbours to be used in calculating the effect of the |
| | behaviour. |

The following includes brief descriptions of examples of group behaviours.

Align With

The Align With behaviour allows an AIE to maintain the same orientation and speed as other members of a group. The AIE may or may not be a member of the group.

Join With

The Join With behaviour allows an AIE to stay close to members of a group. The AIE may or may not be a member of the group.

An example of parameter that can be used to define this behaviour is the Join Distance, which is similar to the “contact radius” in targeted behaviours. Each member of the group within the neighbourhood radius and outside the join distance is taken into account when calculating the steering force of the behaviour. The join distance is the external distance between the characters (i.e. the distance between the outsides of the bounding spheres of the characters). The value of this parameter determines the closeness that members of the group attempt to maintain.

Separate From

The Separate From behaviour allows an AIE to keep a certain distance away from members of a group. For example, this can be used to prevent a school of fish from becoming too crowded. The AIE to which the behaviour is applied may or may not be a member of the group.

The Separation Distance is an example of parameters that can be used to define this behaviour. Each member of the group within the neighbourhood radius and inside the separation distance will be taken into account when calculating the steering force of the behaviour. The separation distance is the external distance between the AIEs (i.e. the distance between the outsides of the bounding spheres of the AIEs). The value of this parameter determines the external separation distance that members of the group will attempt to maintain.

Flock With

This behaviour allows AIEs to flock with each other. It combines the effects of the Align With, Join With, and Separate From behaviours.

The following table describes parameters that can be used to define this behaviour:

| Parameter | Description |
|---|---|
| Alignment | This parameter allows defining the relative |
| Intensity | intensity of the Align With behaviour. |
| Join Intensity | This parameter allows defining the relative |
| | intensity of the Join With behaviour. |
| Separation | This parameter allows defining the relative |
| Intensity | intensity of the Separate From behaviour. |
| Join Distance | This parameter determines the closeness that |
| | members of the group will attempt to maintain. |
| Separation | This parameter determines the external separation |
| Distance | distance that members of the group will attempt |
| | to maintain. |

State Change Behaviours

State Change behaviours allow changing AIEs' states. Examples of State Change behaviours will now be provided.

State Change On Proximity

The State Change On Proximity behaviour allows an AIE's state to be changed based on its distance from a target. For example, the “alive” state of a soldier can be change to false once an enemy kills him.

Examples of parameters allowing defining the State Change On Proximity behaviour:

| Parameter | Description |
|---|---|
| Trigger Radius | This parameter allows defining the external distance |
| | between the two AIEs at which the State Change |
| | behaviour is triggered. |
| Probability | This parameter allows defining the probability |
| | that the state change is triggered at each frame if |
| | the AIEs are within the trigger radius. The value |
| | ranges between 0 and 1. 0 means that the state |
| | change will not occur and 1 means that the |
| | state change will definitely occur. |
| Changing State | This parameter allows defining the state of the |
| | source character to be changed. |
| Change Action | This parameter is assigned one of the following |
| | values: |
| | AbsoluteValue: sets the state to the Change Value. |
| | AbsoluteBoolean: assumes the Change Value is a |
| | Boolean and changes the state to that. |
| | ToggleBoolean: assumes the state is a Boolean value |
| | and toggles it. |
| | Increment: Increments the value of the state by 1. |
| | Decrement: Decrements the value of the state by 1. |
| Change Value | This parameter allows defining the new value of |
| | the state. |
| Use Default Value | This parameter allows defining whether or not the |
| | value of the state will be set to the default value |
| | if the target does not exist or if the target is |
| | outside the activation radius. |
| Default Value | If Use Default Value is on, then the value of the |
| | state will be set to this value if the target does |
| | not exist or if the target is outside the activation |
| | radius. |

Target State Change On Proximity

The Target State Change On Proximity behaviour is similar to the State Change On Proximity behaviour with a difference that it affects the target character's state. For example, a shark kills a fish (i.e. change the fish's “alive” state to false) as soon as the shark is within a few centimetres of the fish.

The following table includes examples of parameters that can be used to define this behaviour:

| Parameter | Description |
|---|---|
| Trigger Radius | This parameter allows defining the external distance |
| | between the two AIEs at which the state change |
| | behaviour is triggered. |
| Probability | This parameter allows defining the probability of |
| | the state change being triggered at each frame if |
| | the AIEs are within the trigger radius. The value |
| | ranges between 0 and 1. 0 means that the state |
| | change will not occur and 1 means that the state |
| | change will definitely occur. |
| Changing State | This parameter allows defining the state of the |
| | target AIE to be changed. |
| Change Action | This parameter can take any of the following values: |
| | AbsoluteValue: sets the state to the Change Value. |
| | AbsoluteBoolean: assumes the Change Value is a |
| | Boolean and changes the state to that. |
| | ToggleBoolean: assumes the state is a Boolean |
| | value and toggles it. |
| | Increment: Increments the value of the state by 1. |
| | Decrement: Decrements the value of the state by 1. |
| Change Value | This parameter allows defining the new value of the |
| | state. |
| Use Default Value | This parameter allows defining whether or not the |
| | value of the state will be set to the default value |
| | if the target does not exist or if the target is |
| | outside the activation radius. |
| Default Value | Use Default Value is on, then the value of the |
| | state will be set to this value if the target does |
| | not exist or if the target is outside the |
| | activation radius. |

Combining Behaviours

An AIE can have multiple active behaviours associated thereto at any given time. Since the possibility that these behaviours be in conflict with each other could arise, the method and system for on-screen animation of digital entities according to the present invention provides means to assign importance to a given behaviour.

A first means to achieve this is by assigning intensity and priority to a behaviour. The assigned intensity of a behaviour affects how strong the steering force generated by the behaviour will be. The higher the intensity the greater the generated behavioural steering forces. The priority of a behaviour defines the precedence the behaviour should have over other behaviours. When a behaviour of a higher priority is activated, those of lower priority are effectively ignored. By assigning intensities and priorities to behaviours the animator informs the solver which behaviours are more important in which situations in order to produce a more realistic animation.

In order for the solver to calculate the new speed, position, and orientation of an AIE, the solver calculates the desired motion of all behaviours, sums up these motions based on each behaviour's intensity, while ignoring those with lower priority, and enforces the maximum speed, acceleration, deceleration, and turning radii defined in the AIE's attributes. Finally, braking due to turning may be taken into account. Indeed, based on the values of the character's Braking Softness and Brake Padding attributes, the character may slow down in order to turn.

Providing, for example, the case of a school of fish and a hungry shark in a large aquarium, and more specifically the case where a fish wants to escape the hungry shark. At this point in time both the fish's “Flee From” shark and “Flock With” other fish behaviours will be activated causing two steering forces to act on the fish in unison. Therefore, the fish tries to escape the shark and stay with the other fish at the same time. The resulting active steering force on the fish will be the weighted sum of the individual behavioural forces, based on their intensities. For example, for the fish, it is much more important to flee from the shark than to stay in a school formation. Therefore, a higher intensity is assigned to the fish's “Flee From” behaviour than to the “Flock With” behaviour. This allows the fish to break formation when trying to escape the shark and then to regroup when it is far enough away from the shark.

Although the resulting behaviour can be achieved simply by adjusting intensities, ideally when the fish sees the shark it would disable its “Flock With” behaviour and enable its “Flee From” behaviour. Once out of range of the shark, the fish would then continue to swim in a school by disabling its “Flee From” behaviour and enabling its “Flock With” behaviour. This type of behavioural control can be achieved by setting the behaviours' priorities. By giving the “Flee From” behaviour a higher priority than the “Flock With” behaviour, when a fish is fleeing from a shark, its “Flock With” behaviour will be effectively disabled. Therefore, a fish will not try to remain with the other fish while trying to flee the shark, but once it has escaped the shark its “Flock With” behaviour will be reactivated and the fish will regroup with its school.

In many relatively simple cases such as described in this last example, to obtain a realistic animation sequence it is usually sufficient to assign various degrees of intensities and priorities to specific behaviours. However, in a more complicated scenario, simply tweaking a behaviour's attributes may not produce acceptable results. In order to implement higher-level behaviour, an AIE needs to be able to make decisions about what actions to take according to its surrounding environment. The following section describes how an AIE uses sensors to gather data information image object elements or other AIE in the digital world (step 108) and how decisions are made and action selected based on this information (step 110).

For example, to cause a character to move along a path but run away from any nearby enemies, the following logic can be implemented:
if an enemy is near,
   then: run away
   else: follow the path.

This relatively simple piece of logic can be divided as follows:

1. The conditional: “if enemy is near”.

2. The Actions: “run away”, or “follow the path”, depending of the current state of the conditional.

In the method 100, the conditional is implemented by creating a Sensor, which will output its findings to an element of the character's memory called a Datum.

The Actions are implemented using Commands. Commands can be used to activate behaviours or animation cycles, to set character attributes, or to set Datum values. In this example, the commands would activate a FleeFrom behaviour or a FollowPath behaviour for example.

Finally, a Decision Tree is used to group the Actions with the Conditional. A Decision Tree allows nesting multiple conditional nodes in order to produce logic of arbitrary complexity.

Data Information

An AIE's data information can be thought of as its internal memory. Each datum is an element of information stored in the AIE's internal memory. For example, a datum could hold information such as whether or not an enemy is seen or who is the weakest ally. A Datum can also be used as a state variable for an AIE.

Data are written to by a character's Sensors, or by Commands within a Decision Tree. The Datum's value is used by the Decision Tree to activate and deactivate behaviours and animations, or to test the character's state. Sensors and Decision trees will be described hereinbelow in more detail.

Sensors

AIEs use sensors to gain information about the world. A sensor will store its sensed information in a datum belonging to the AIE.

A parameter can be used to trigger the activation of a sensor. If a sensor is set off, it will be ignored by the solver and will not store information in any datum.

Example of sensors that can be implemented in the method 100 will now be described in more detail. Of course, it is believed to be within the reach of a person skilled in the art to provide additional or alternate sensors depending on the application.

Vision Sensor

The vision sensor is the eyes and ears of a character and allows the character to sense other physical objects or AIEs in the virtual world, which can be autonomous or non-autonomous characters, barriers, and waypoints, for example.

The following parameters allow, for example, defining the vision sensor:

| Parameter | Description |
|---|---|
| Visibility | This parameter allows defining the maximum distance |
| Distance | from the AIE that it can sense other objects i.e. |
| | how far can the AIE see. The visibility distance |
| | is the external distance between the AIE, i.e. |
| | the distance between the outsides of the |
| | bounding spheres of the AIEs. |
| Visibility | This parameter allows defining the following four |
| Angles | angles: Visibility Right Angle, Visibility Left |
| | Angle, Visibility Up Angle, and Visibility Down |
| | Angle, specify the field of view of the visibility |
| | sensor measured in degrees. Any object outside the |
| | frustum defined by these angles will be ignored. |
| Can See | If this parameter is set to off, then the sensor |
| Through | will not sense objects behind opaque barriers. |
| Opaque | |
| Barriers | |
| Object Type | This parameter allows defining the type of objects |
| Filter | this sensor will look for. The options are: All |
| | Objects, Barriers, Way Points, or AIEs. For example, |
| | if Barriers is chosen then the sensor will only |
| | find barriers. |
| Object Filter | This parameter allows defining the objects this |
| | sensor will look for. If this is set to a group, |
| | then the sensor will only look for objects in the |
| | selected group. If this is set to a path, then the |
| | sensor will only look for waypoints on the path. |
| | If this is set to a specific object (e.g. a |
| | character, a waypoint, or a barrier), then the |
| | sensor will ignore all other objects in the world. |
| Evaluation | This parameter allows defining the evaluation |
| Function | function assigns a value to each sensed object. |
| | The value of the object, in conjunction with the |
| | Min Max attribute, is used to determine |
| | the “best” object of all the ones sensed. |
| | The possible values are: |
| | Any: this chooses the first object sensed. This |
| | is the most efficient value of the Evaluation |
| | Function. This value could possibly choose the |
| | same object every time. If you want a randomly |
| | selected object, set the value of the Evaluation |
| | Function to “Random”. |
| | Distance: this chooses an object based on its |
| | distance from the character. If the Min Max |
| | attribute is set to minimum, the nearest object |
| | to the AIE is chosen. If the Min Max attribute |
| | is set to maximum, the furthest object |
| | (within the visibility distance) to the AIE is |
| | chosen. |
| | Random: this randomly chooses an object. |
| Min Max | This parameter allows defining whether the object |
| | with the minimum or maximum value is considered |
| | the “best” object. |
| Is Any Object | This parameter allows defining the datum that will |
| Seen Datum | be used to store whether or not any object was seen, |
| | i.e. did the AIE see what it was looking for. |
| Best Object | This parameter allows defining the datum that will |
| Datum | be used to store which “best” object that |
| | was sensed, i.e. what exactly did the AIE see. |

Property Sensor

The Property sensor is a general-purpose sensor allowing to return and filter the value of any of an AIE's state, speed, angular velocity, orientation, distances from target, group membership, datum values, bearing, or pitch bearing.

Unlike other sensors, the property sensor can sense the properties of any AIE in the simulation.

The following table includes a list of parameters that can be used to define the Property sensor:

| Parameter | Description |
|---|---|
| Property | This parameter allows defining the property to be |
| Type | sensed. Options are: |
| | State: Returns the value of the specified state |
| | variable of the targeted AIE. |
| | Random: Returns a value between the 0 and 1. There |
| | is no target AIE for this property type. |
| | Speed: Returns the current speed of the targeted AIE. |
| | Angular Velocity: Returns the angular velocity of the |
| | targeted AIE. This angle is measured in degrees. |
| | Distance: Returns the distance from the targeted |
| | object. |
| | Group Membership: Returns whether or not the AIE is a |
| | member of the specified group. |
| | Datum Value: Returns the value of the specified datum. |
| | Bearing: Returns the difference about the Y axis |
| | between the forward orientation of an AIE and the |
| | direction of motion of the AIE. The value returned |
| | is in degrees. |
| | Pitch Bearing: Returns the difference about the X |
| | axis between the forward orientation of an AIE and |
| | the direction of motion of the AIE. The value |
| | returned is in degrees. |
| | Surface Slope: Returns the angle in degrees between |
| | the horizontal and the surface in the direction |
| | the AIE is climbing a vertical cliff, −45 for |
| | going down a 45° slope). |
| Target | The following parameter allows defining the AIE |
| | whose property is to be sensed. “Self” (the |
| | default setting) will cause the selected AIE |
| | (i.e. the owner of the sensor) to be sensed. |
| Result Datum | The value sensed is stored in the result datum. |
| | For example, a speed sensor will return the speed |
| | of an AIE as a float value to the result datum. |
| Filter Type | Filters are used to evaluate the data returned |
| | from a sensor and pass a Boolean value to the |
| | Filtered Result Datum. |
| Is Same As | The Filtered Result Datum will be used to store |
| | whether or not the value is exactly the same as |
| | the specified value. |
| Is At Least | The Filtered Result Datum will be used to store |
| | whether or not the value is at least the specified |
| | value. |
| Is At Most | The Filtered Result Datum will be used to store |
| | whether or not the value is at most the specified |
| | value. |
| Is In Range | The Filtered Result Datum will be used to store |
| | whether or not the value is between Minimum and |
| | Maximum. |
| Filtered | The Boolean result of the filter operation is |
| Result Datum | stored here. |

Random Sensor

A random sensor returns a random number within a specified range. The following table includes examples of parameters that allow to define the Random sensor:

| Parameter | Description |
|---|---|
| Minimum | This parameter allows defining the start of the range. |
| Maximum | This parameter allows defining the end of the range. |
| Value Datum | This parameter allows defining the datum that will |
| | be used to store the random value. If the type |
| | attribute of this datum is Boolean, then a random |
| | number between 0 and 1 will be generated, and the |
| | datum will be set to true if that number falls |
| | within the range indicated by the Minimum and Maximum |
| | attributes. |

Value Sensors

A value sensor allows setting the value of a datum based on whether or not a certain value is within a certain range.

The following table includes examples of parameters that can be used to define the Value sensor:

| Parameter | Description |
|---|---|
| Minimum | This parameter allows defining the start of the range. |
| Use Minimum | If this parameter is set to off, the start of the |
| | range is considered to be negative infinity. |
| Maximum | This parameter allows defining the end of the range. |
| Use Maximum | If this parameter is set to off, the end of the |
| | range is considered to be infinity. |
| Is Value In | This parameter allows defining the datum that |
| Range Datum | will be used to store whether or not the value is |
| | between Minimum and Maximum. |

Speed Sensor

A speed sensor is a value sensor that sets the value of a boolean datum based on the speed of the AIE. For example, this sensor can be used to change the animation of an AIE from a walk cycle to a run cycle.

The Property sensor can be used to read the actual speed of an AIE into a datum.

The following table includes examples of parameters that can be used to define the Speed sensor:

| Parameter | Description |
|---|---|
| Minimum | This parameter allows defining the start of the range. |
| Use Minimum | If this is parameter is set to off, then the start |
| | of the range is considered to be negative infinity, |
| Maximum | This parameter allows defining the end of the range. |
| Use Maximum | If this parameter is set to off, then the end of the |
| | range is considered to be infinity. |
| Is Value In | This parameter allows defining the datum that will |
| Range Datum | be used to store whether or not the value is between |
| | Minimum and Maximum. |

State Sensor

A state sensor allows setting the value of a boolean datum based on the value of one of the AIE's states. For example, in a battle scene such a sensor can be used to allow AIEs with low health to run away by activating a Flee From behaviour when their “alive” state reaches a low enough value.

The following tables includes examples of parameters that can be used to define a state sensor:

| Parameter | Description |
|---|---|
| State | The following parameter allows defining the state |
| | to be used. |
| Minimum | The following parameter allows defining the start |
| | of the range. |
| Use Minimum | If this parameter is set to off, the start of the |
| | range is considered to be negative infinity. |
| Maximum | The following parameter allows defining the end of the |
| | range. |
| Use Maximum | If this parameter is set to off, the end of the |
| | range is considered to be infinity. |
| Is Value In | The following parameter allows defining the datum |
| Range Datum | that will be used store whether or not the value |
| | is between Minimum and Maximum. |

Active Animation Sensor

An active animation sensor can set the value of a datum based on whether or not a certain animation is active.

The following tables includes examples of parameters that can be used to define a state sensor:

| Parameter | Description |
|---|---|
| Animation | This parameter allows defining the animation to be |
| | sensed. |
| Is Animation | This parameter allows defining the datum that will |
| Active Datum | be used to store whether or not the animation is active. |

Commands, Decisions, and Decision Trees

As illustrated in steps 110-114 of FIG. 1, decision trees are used to process the data information gathered using sensors.

Step 110 results in a Command being used to activate a behaviour or an animation, or to modify an AIE's internal memory.

Commands are invoked by decisions. A single Decision consists of a conditional expression and a list of commands to invoke.

A Decision Tree consists of a root decision node, which can own child decision nodes. Each of those children may in turn own children of their own, each of which may own more children, etc.

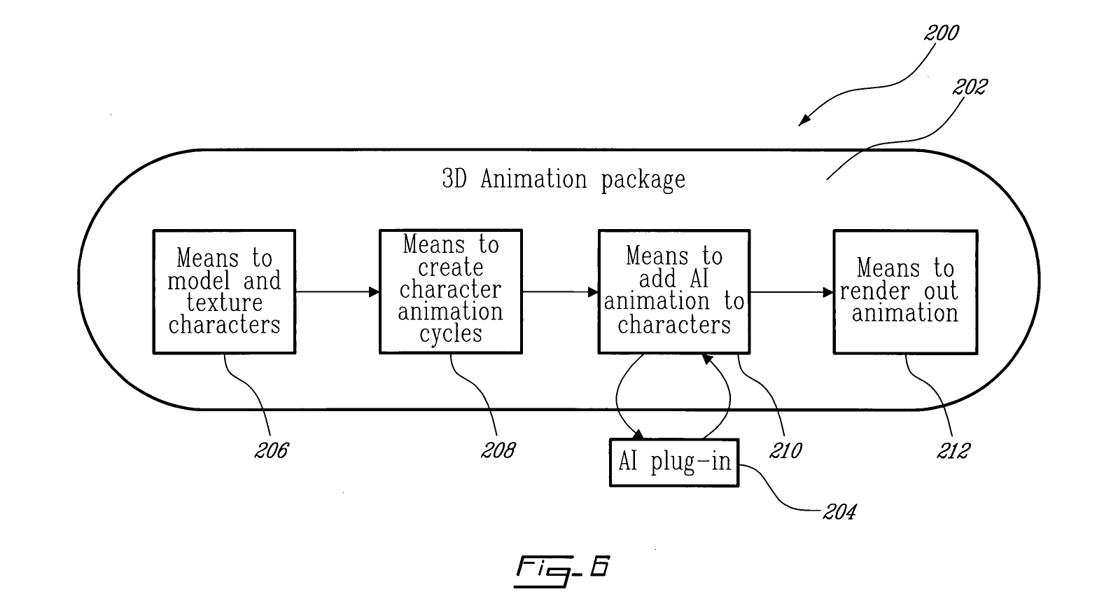

FIG. 5 illustrates a method of use of a Decision Tree to drive Action Selection. The method of FIG. 5 corresponds to step 110 on FIG. 1.

Since the method 110 iterates on all frames, verification is done in step 118 to verify whether all frames have been processed. A similar verification is done in step 120 for the AIEs.

In step 122, all of the current AIE's behaviours are deactivated.

In step 124, verification is done to insure that all decision trees have been processed for the current AIE.

Then, for each decision tree, the root decision node is evaluated (step 126), all commands in the corresponding decision are invoked (step 128), and the conditional of the current decision tree is evaluated (step 130).

It is then verified in step 132, whether all decision nodes have been processed. If yes, the method 110 proceeds with the next decision tree (step 124). If no, the child decision node indicated by the conditional is evaluated (step 134), and the method returns to the next child decision node (step 132).

For the example given hereinabove, where a character moves along a path while running away from any nearby enemies, the following elements can be created:
two behaviours: FleeFromEnemy and FollowPath;
a datum called IsEnemySeen for the character to store whether or not it sees the enemy;
a vision sensor that looks for the enemy. This would feed into the Is EnemySeen datum; and U the following decision tree:

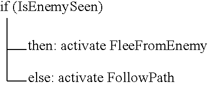

It results from the above decision tree that when the character sees the enemy, it will activate its Flee From behaviour and if the character does not see the enemy it will activate its Follow Path behaviour.

Note that if an AIE is assigned a decision tree, the solver deactivates all behaviours before solving for that AIE (step 122 in FIG. 5). In this last example, at every frame, both the “FleeFromEnemy” and “FollowPath” behaviours are deactivated. Then, based on the value of the “IsEnemySeen” datum, one of them is reactivated.

A parameter indicative of whether or not the decision tree is to be evaluated can be used in defining the decision tree.

Whenever the command corresponds to activating an animation and a transition is defined between the current animation and the new one, then that transition is first activated.

Similarly, whenever the command corresponds to activating a behaviour, a blend time can be provided between the current animation and the new one.

Moreover, whenever the command corresponds to activating a behaviour, the target is changed to the object specified by a datum. For example, to make a character flee from the nearest enemy:
a group called “enemies” can be created to include all the ennemies;
a “Flee From” behaviour is created for the character called “FleeFromNearestEnemy”. At this point the target of the behaviour is not yet defined;
a datum is added to the character, called “NearestEnemy”;
another datum is assigned to the character, called “IsAnyEnemySeen”;
a vision sensor is created and assigned to the character called “EnemySensor”. This cause the “enemies” to group as an object filter, “distance” as the evaluation function, “minimum” as the value for the Min Max attribute (if “maximum” is chosen, then the seen enemy within the visibility distance will be chosen). Also, the “Is Any Object Seen” datum is set to “IsAnyEnemySeen” and the “Best Object” datum to “Nearest Enemy”. If an enemy is within the sensor's visibility distance “IsAnyEnemySeen” will be set to true and “NearestEnemy” will contain a reference to the nearest enemy, otherwise if no enemy is seen, “IsAnyEnemySeen” will be set to false;
a DecisionTree is created as follows: 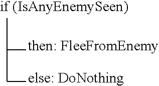
the FleeFromEnemy decision results in a Change Behaviour Target Command with “FleeFromNearestEnemy” as the behaviour and “NearestEnemy” as the datum (meaning change the target of the “FleeFromNearestEnemy” behaviour to the value of the “NearestEnemy” datum).

Examples of command that can be used with the method 100, and more specifically in step 112 or 114, will be described.

Queue Animation Command

This command can be used to activate an animation (the “New Animation”) once another one (the “Old Animation”) completes its current cycle. For example, a queue animation with a walk animation as the “Old Animation”, and a run animation as “New Animation”, will activate the run animation as soon as the walk animation finishes its current cycle.

It is to be noted that the same result can be achieved by defining a Queuing transition between the animations, then using a normal ActivateAnimation command.

Set Datum Command

This command can be used to set (or increment, or decrement) the value of a datum. If the datum represents an AIE's state, then this command can be used to transition between states.

Set Value Command

This command allows setting (or increment, or decrement) the value of any attributes of one or more AIEs or character characteristics (such as behaviours, sensors, animations, etc).

In particular, this command may be used to set a character's position and orientation, active state, turning radii, surface offset, etc.

The set value command may include two parts: the Item Selection part for specifying which items are to be modified, and the Value section for specifying which of the item's attributes are to be modified.

Group Membership Command

This command can be used to add (or remove) an AIE to (from) a group. Also, such a command may be used to remove all members from a group.

Animation Control

It will now be described how animation clips are associated to AIEs and how an AIE drives the right animation clip at the right time and speed.

Animation clips can be defined for example using one of the following parameters:

| Parameter | Description |
|---|---|
| Active | This parameter allows defining whether or not the |
| | animation is active |
| Length | This parameter allows defining the number of frames the |
| | animation will take to perform a full cycle. Normally, |
| | this number would correspond to the length of the |
| | clip itself. If it doesn't, then the animation will |
| | be scaled to fit the length indicated by this |
| | attribute. |
| Speed | This parameter allows defining whether or not the |
| Adjusted | animation depends on the speed of the AIE. If so, |
| | the faster the AIE moves, the faster the animation |
| | is played. For example, a walk clip should be speed |
| | adjusted but an idle clip should not. |
| Preferred | If Speed Adjusted is set to off, this parameter is |
| Speed | ignored. Otherwise, it defines the speed of an AIE |
| | at which the animation will take as many frames as |
| | defined by the Length attribute to perform a full |
| | cycle. For example, if a walk clip has a length of |
| | 10 and a preferred speed of 3, then the walk clip |
| | will take 10 frames to perform a full cycle when |
| | the AIE moves at a speed of 3. However, if the AIE |
| | moves at a speed of 6 it will take only 5 frames. |
| Cyclic | This parameter allows defining whether or not the |
| | animation clip will repeat itself. A non-cyclic |
| | animation will only perform one cycle when it is |
| | activated. |
| Interruptible | If this parameter is false, then no other animation |
| | may be activated for this AIE until this animation |
| | finishes. Default value is true. |

Animation Selection

Action Selection allows, for example, to switch between an idle animation and a walk animation based on its speed. In this particular case the first step is to create a datum for the character, which might be called “IsWalking”. Next, a speed sensor is created to drive the datum. Then the following decision tree is created to activate the correct animation depending on the speed of the character:

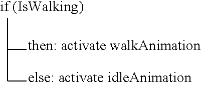

Thus, at each frame, either the walk or idle clip would be played based on the value of the IsWalking datum.

Action Selection effectively allows activating the right animation at the right time, and adjusting its scale and number of cycles appropriately.

Animation Transitions and Blending

While animation commands are used to activate or deactivate clip animations at the appropriate time, animation transitions are used in order to specify what happens if an animation is already playing when another one is activated. This allows creating a smooth transition from one animation to another. In particular, animation transitions make it possible to smoothly blend one clip into another.

Before describing in more detail the action selection and the use of transitions between the activation of animation clips, the following terminology is introduced:

Animation channel: attributes of objects with animation curves;

Animation clip: a list of channels and their associated animations. Typically the animation of each channel is defined with a function curve, that is, a curve specifying the value of the parameter over time. This concept promotes animation reuse, over several characters and over time for a given AIE. It does this by scaling, stretching, offsetting the animation and possibly fitting it for a specific AIE. Common examples for a clip are walk or run cycles, death animations, etc.

Animation blending: a process that computes the value for a channel by averaging two or more different clips, in order to get something in-between. This is generally controlled by a weight that specifies the amount of each animation to use in the mix.

Interpolation/Transitions: a blending that occurs from either a static, non-animated posture to a new pose or animation, or an old animation to a new one where the new animation is expected to take over completely over a transition time.

Marker: used to define a reference point in an animation clip for transitions. For example in the last frame of the “in” animation clip a character has their right foot on the ground, the marker could then be used to define a similar position in the “out” animation to transition to.

Animation markers are reference points allowing synchronizing clips. They are used to synchronize transitions between two clips.

The following table includes example of parameters that can be used to define animation markers:

| Parameter | Description |
|---|---|
| Available | This parameter allows defining markers that currently |
| Markers | available to be used. |
| Markers used | This parameter allows defining markers that are |
| in this | used within the current animation. When selected all |
| animation | corresponding animations that utilize that same |
| | animation marker can be displayed to the |
| | user so as to help setting animation. |

The following table includes example of parameters allowing to define animation blending:

| Parameter | Description |
|---|---|
| Start Marker | This parameter allows defining which marker will be |
| | used to start the new animation. If no marker is |
| | specified then the beginning of the animation will |
| | be used. |
| Blending | This parameter allows defining a period of time over |
| | which both animations will be playing simultaneously, |
| | the old progressively morphing into the new. The |
| | following two parameters allows controlling the blend |
| | into the incoming animation: |
| BlendDuration | The length of the blend in frames. |
| Blend Type | Linear or smooth. Linear is a constant progression |
| | while a smooth blend is an ease-in/ease-out transition. |

| Parameter | Description |
|---|---|
| Transition Type | The type “Interrupt” allows for an immediate transition to a new animation as illustrated in the following example. |
| | 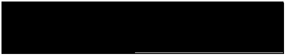 |
| | The type “Queue” allows for a transition that occurs only |
| | when the current cycle of animation is complete, as illustrated |
| | in the following example. |
| | 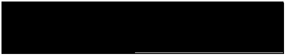 |
| | The type “AutoSynchronize” allows for a transition using |
| | common markers between animations. The current animation |
| | will continue to play until it reaches the next common marker |
| | and only then will the transition occur. For example, in the |
| | in_animation, a marker is created at frame 30. The same |
| | marker is used for animation clip 2 at frame 25. The resulting |
| | transition will always occur at frame 30 for the in clip and 25 |
| | for the out clip, as illustrated in the following example. |
| | 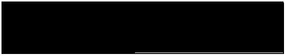 |
| | When transitioning between cycled clips, AutoSynchronize |
| | will attempt to dynamically choose the most appropriate |
| | transition point for the incoming clip based on the position |
| | position of a common marker |
| In- | |
| between | This parameter allows defining the option of playing another, |
| animation | third animation before moving on to the new animation. If |
| | an in-between animation is used, there will be additional |
| | blending parameters. |
| In- | |
| between | If one uses an in-between animation, then there are in fact 2 |
| blend | transitions that will occur: one between the old animation and |
| | the in-between animation, and another between the in-between |
| | animation and the new. The parameters used for the latter are |
| | the ones we saw previously. For the former one, an in- |
| | between blend duration and a blend type are specified. |
| | * If there is no transition defined between two animations, |
| | then for the moment a transition type of interrupt is used, |
| | and a blend time as controlled by the character attribute |
| | “Default Animation Blend Time” (whose default value |
| | is zero). |

It is to be noted that character's attributes can also be used to define animation. The following table includes examples of such character's attributes:

| Parameter | Description |
|---|---|
| Default | If no transition is defined between two animations |
| Animation | the default Animation Blend Time allows creating an |
| Blend Time | interrupt transition of the specified length. |
| First | This parameter allows specifying the initial frame |
| Animation | of animation played for the first active animation |
| Frame | of an AIE. |

According to a further aspect of the present invention, waypoints are provided for marking spherical region of space in the virtual world.

Characteristics and functions of waypoints will be described with reference to the following table, including examples of parameters that can be used to define waypoints:

| Parameter | Description |
|---|---|
| Exists | This parameter allows defining whether or not the |
| | waypoint exists in the solver world. If this is set |
| | to off the solver ignores the waypoint. |
| Collidable | This parameter allows defining whether or not |
| | collisions with other collidable objects will be |
| | resolved. |
| Radius | This parameter allows defining the radius of the |
| | waypoint's bounding sphere. When an AIE follows a |
| | path, if it is inside the bounding sphere of a |
| | waypoint the AIE will seek to the next waypoint. |
| Speed | This parameter is only used for Paths, as will be |
| Limit | described hereinbelow. It indicates the desired |
| | speed an AIE will have when approaching this waypoint |
| | when following the path. This speed limit will only |
| | be heeded if the Use Speed Limits attribute of the |
| | Follow Path behaviour has been set to on. |
| IsPortal | This parameter is only used for Waypoint Networks, |
| | which will be described hereinbelow. It Informs the |
| | solver that this waypoints stands at the doorway to |
| | a room. The solver uses this information |
| | to optimize performance for large networks. |

Waypoints allow to creates a path, which is an ordered set of waypoints that AIE may be instructed to follow. For example, a path around a racetrack would consist of waypoints at the turns of the track.

Each waypoint can be assigned speed limits to control how the AIE approaches it (e.g. approach this waypoint at this speed). Paths can be used to build racetracks, attack routes, flight paths, etc.

Also, linking together waypoints with edges may create a waypoint network. For example, a character with a SeekToViaNetwork behaviour can use a waypoint network to navigate around the world. An edge between a waypoint in the network to another waypoint in the same network indicates that an AIE can travel from the first waypoint to the second. The lack of an edge between two waypoints indicates that an AIE cannot travel between them.

A waypoint network functions in a similar manner to a path however, the exact route that the autonomous character takes is not pre-defined as the character will navigate its way via the network according to its environment. Essentially a waypoint network can be thought of as a dynamically generated path. Collision detection is used to ensure that AIEs do not penetrate each other or their surrounding environment.

According to a further specific aspect of the present invention, there is provided a method for generating waypoints network. The method includes analyzing the level, determining all reachable areas and placing the minimum necessary waypoints for maximum reach ability. For example, reachable waypoints can be positioned within the perimeter of the selected barriers, and outside barrier enclosed unreachable areas or “holes”.

It is to be noted that a waypoint can be positioned in the virtual world at the entrance to each room and mark is as a portal using a specific waypoint's parameter. Each room can have one Portal waypoint per doorway. Thus any 2 rooms connected by a doorway will have 2 Portal waypoints (one just inside each room) connected by an edge, and all passages or doorways connecting one room to another will have a corresponding edge between 2 Portal waypoints. All other waypoints should have the “IsPortal” parameter set to off. This allows the solver to significantly reduce the amount of run-time memory required to navigate large networks (i.e. >100 waypoints).

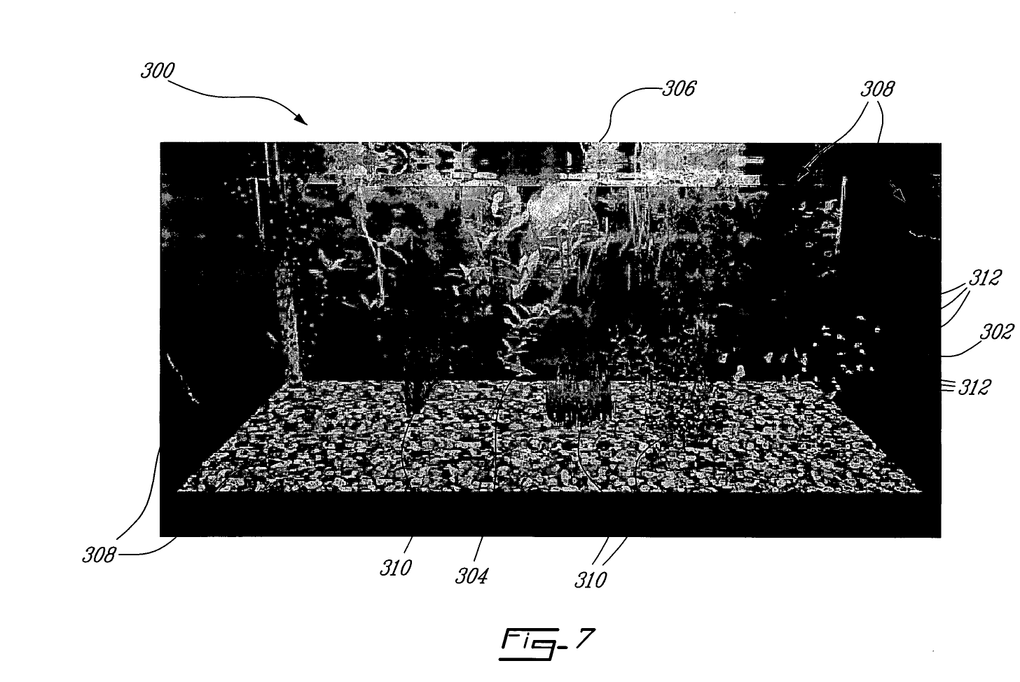

FIG. 6 illustrates a system 200 for on-screen animation of digital entities according to a first illustrative embodiment of a second aspect of the present invention. The system 200 is in the form of a computer application plug-in 204 embodying the method 100 and inserted into the pipeline and workflow of an existing computer animation package (or platform) 202, such as Maya™ by Alias Systems, and 3ds-max™ from Discreet. Alternatively, it can also be implemented as a stand-alone application.

The animation package 202 includes means to model and texture characters 206, means for creating animation cycles 208, means to add AI animation to characters 210, and means to render out animation 212. Since those last four means are believed to be well known in the art, and of concision purposes, they will not be described herein in more detail.

The plug-in 204 includes an autonomous entity engine (AEE) (not shown), which calculates and updates the position and orientation of each AIE for each frame, chooses the correct set of animation cycles, and enables the correct simulation logic.

The plug-in 204 is designed to be integrated directly into the host art package 202, allowing animators to continue animating their AIE via the package 202, rather than having to learn a new technology. In addition, many animators are already familiar with specific animation package workflow, so learning curves are reduced and they can mix and match functionality between the package 202 and the plug-in 204 as appropriate for their project.

The system 200 may include a user-interface tool (not shown) for displaying specific objects and AIEs from the digital world, for example, in a tree view structure orientated from an artificial perspective. This tool allows selecting multiple objects and AIEs for editing one or more of their attributes.

Furthermore, a Paint tool (not shown) can be provided to organize, create, position and modify simultaneously a plurality of AIEs. The following table includes examples of parameters that can be used to define the effect of the paint tool:

| Parameter | Decription |
|---|---|
| Group Name: | This parameter allows specifying the name of the |
| | current group or paint layer. |
| Group: | This parameter allows specifying the currently |
| | active group. |
| Individuals: | This parameter allows specifying the name for a |
| | subgroup or paint layer. |
| Individual | This parameter allows specifying the currently |
| names: | active Individual group. |
| Variation: | Variations add a version number to the full name |
| | of the proxy character, i.e. |
| | Warrior_Var10_Roman_Grp1. |
| | This then would read as the Warrior of type 10 that |
| | is member of the Roman group. |
| Assign | This parameter allows applying the selected vertex |
| Vertex | color to the active layer. |
| Color: | |
| Proxy: | This parameter allows creating new proxy characters |
| Create/ | or modifies existing AIEs based on the active |
| Modify | Control options. |
| Proxy: | This parameter allows modifying proxy characters |
| Modify | based active Control options. This is useful to |
| | perturb the position orientation and scale of |
| | an AIE. |
| Proxy: | This parameter allows removing the proxy AIEs. |
| Remove | |
| Selection: | This parameter allows selecting deselecting or |
| Select | toggling the current selection. |
| Deselect | |
| Toggle | |
| Modify:/ | This parameter allows selecting the type of object |
| Create: | to modify or create. |
| Paint | This parameter allows selecting the attribute to |
| Attribute: | paint the value of. |
| Grid | This parameter allows enabling objects to be |
| | painted at positions other than the vertices. |
| Jitter | This parameter allows randomizing the placement of |
| Grid | objects. |
| U V Grid | This parameter allows defining the density of |
| Size: | painted objects. |
| Control: | This parameter allows controlling options used |
| | to specify which transform attributes are to |
| | be modified. |
| Options: | This parameter allows parenting Proxy characters |
| Group | to a group node. |
| Options: | This parameter allows aligning proxy characters |
| Align | to the normal of the surface. |
| Jitter | This parameter allows defining a percentage of |
| Value: | randomness applied to the Jitter Grid. |
| Vertex | This parameter allows enabling the vertex color |
| Color | display for the active layer. |
| Display | |

The system 200 for on-screen animation according to the present invention provides for means to duplicate the attributes from a first AIE to a second AIE. The attributes duplication means may include a user-interface allowing selecting the previously created recipient of the attributes, and the AIE from which the attributes are to be copied. Of course, the duplication may extent also to behaviours, animation clips, decision tree, sensors and to any information associated to an AIE. The duplication allows to simply and rapidly create a group of identical AIE.

More specifically, options are provided to precise the attribute duplication process, such as:

| Option | Description |
|---|---|
| Copy Key | This option defines whether or not any key frames and |
| Frames | driven keys on the source AIE should be duplicated. |
| | If this option is not selected, any attributes controlled |
| | by key frames (or are driven keys) have only their values |
| | duplicated. |
| Copy | This option defines whether or not any expressions on the |
| Expressions | source AIE should be duplicated. If this option is not |
| | selected, any attributes controlled by expressions only |
| | have their values duplicated. |
| Tag Proxy | This option defines whether or not the proxy AIE should |
| | have connection information written to later reconnect |
| | animations. |
| Copy | This option defines whether or not the behaviours of the |
| Behaviours | source AIE should be duplicated. |
| Copy | This option allows defining whether or not the animations |
| Animations | associated to the source AIE should be duplicated. |
| Copy Action | This option defines whether or not the action selection |
| Selection | components of the source AIE should be duplicated. This |
| | includes data, sensors, decision trees, decisions, and |
| | commands. |
| Copy Groups | This option defines whether or not the destination AIEs |
| | should be put in the same group or groups as the source |
| | autonomous character. |
| Remove | This option defines whether or not the AIEs (if any) |
| Autonomous | of the destination objects should be removed before |
| Characters | duplication of the source object. If this is selected |
| | then all the Artificial Intelligence (AI) specific |
| | information of the destination AIE, except for its name, |
| | is removed before duplication. If this is not set, then |
| | the components of the source AIE are added to |
| | those of the destination AIEs. |
| Remove | This option defines whether or not the behaviours of the |
| Behaviours | destination AIEs should be removed before duplication. |
| | If this option is not selected, then the behaviours of |
| | the source AIE are added to those of the destination AIEs. |
| Remove | This option defines whether or not the animations of the |
| Animations | destination AIEs should be removed before duplication. |
| | If this option is not selected, then the animations of |
| | the source AIE are added to those of the destination AIEs. |
| Remove | This option defines whether or not the action selection |
| Action | components of the destination AIEs should be removed |
| Selection | before duplication. If this is not selected, then the |
| | action selection components of the source AIE are added |
| | to those of the destination AIEs. Action selection |
| | components include data, sensors, decision trees, |
| | decisions, and commands. |
| Remove | This option defines whether or not the destination AIEs |
| Groups | should be removed from their groups before duplication. |
| | If this option is not ticked, then the groups of the |
| | source AIE are added to the destination AIEs. |

Alternatively or additionally, the duplication process may be performed on an attribute-to-attribute basis.

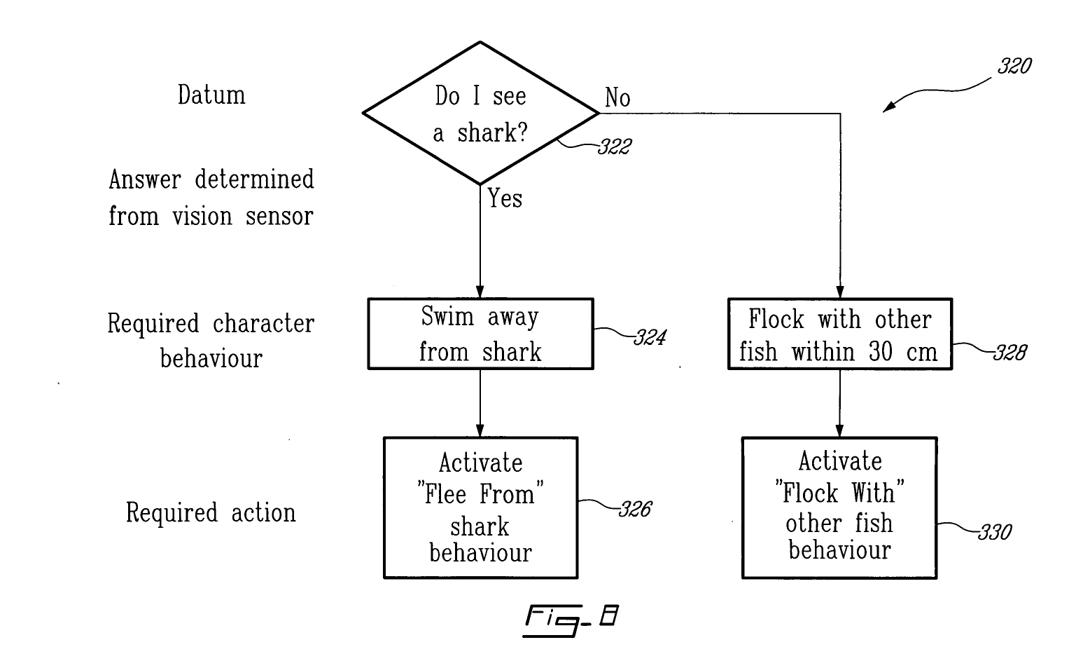

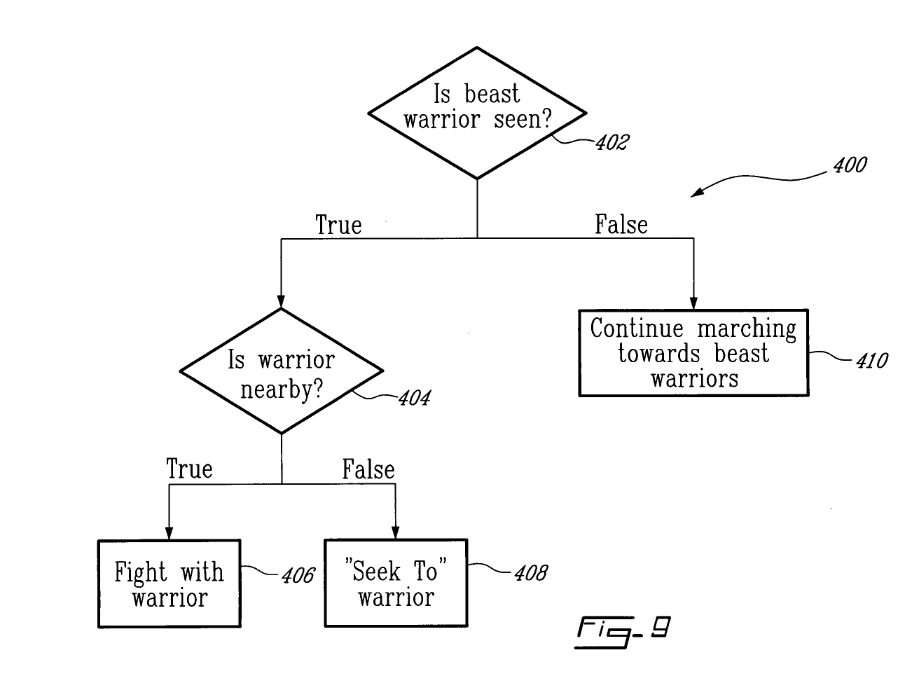

Turning now to FIGS. 7 and 8, the method 100 will now be described by way of a first specific example of application related to the animation of a school of fish 302 and a hungry shark 304 in a large aquarium 306. FIG. 7 illustrates a still image 300 from the computer animation.

The walls of the aquarium are defined as barriers 308 in the virtual world, the seaweed 310 as non-autonomous image entities, and each fish 312 and shark 304 as autonomous image entities.

Each fish 312 is assigned a “Flock With” other fish behaviour so that they all swim in a school formation, as well as a “Wander Around” behaviour so that the school 302 moves around the aquarium 300. To allow a fish 312 to escape the hungry shark 304, it is assigned the behaviour “Flee From” shark. The “Flee From” behaviour is given an activation radius so that when the shark 304 is outside this radius the “Flee From” behaviour would effectively be disabled and only enabled when the shark 304 is inside the radius.

To prevent a fish 312 from hitting other fish 312, the seaweed 310, nor the aquarium walls 308, each fish 312 has the additional behaviours “Avoid Obstacles” (seaweed 310 and the other fish 312) and “Avoid Barriers” (the aquarium walls 308). Similarly to the case in real life, the solver resolves these different behaviours to determine the correct motion path so that, in its efforts to avoid being eaten, a fish 312 avoids the shark 304, the other fish 312 around it, the seaweed 310, and the aquarium walls 308 the best it can.

Considering the case when a fish 312 wants to escape the hungry shark 304. At this point in time, both a fish's “Flee From” shark and “Flock With” other fish behaviours will be activated causing two steering forces to act on the fish 312 in unison. Therefore, a fish 312 will try to escape the shark 304 and stay with the other fish 312 at the same time. The resulting active steering force on the fish 312 will be the weighted sum of the individual behavioural forces, based on their intensities. For example, for the fish 312, it is much more important to flee from the shark 304 than to stay in a school formation 302. Therefore, a higher intensity is assigned to the fish's “Flee From” behaviour than the “Flock With” behaviour. This allows the fish 312 to break formation when trying to escape the shark 304 and then to regroup with the other fish 312 once it is far enough away from the shark 304.

Although simply adjusting the fish's behaviours intensities allow yielding realism, alternatively the “Flock With” behaviour of the fish 312 can be disabled and its “Flee From” behaviour is enable when the fish 312 sees the shark 304. Once out of range of the shark 304, a fish 312 would then continue to swim in a school 302 by disabling its “Flee From” behaviour and enabling its “Flock With” behaviour. This type of behavioural control can be achieved by setting the behaviours' priorities. By giving the “Flee From” behaviour a higher priority than the “Flock With” behaviour, when a fish 312 is fleeing from a shark 304 its “Flock With” behaviour will be effectively disabled. Assigning such priorities to the behaviours causes a fish 312 not to try remaining with the other fish 312, while trying to flee the shark 304. However, once it has escaped the shark 304 the “Flock With” behaviour is reactivated and the fish 312 regroups with its school 302.

In many relatively simple cases such as this one, to obtain a realistic animation sequence, it is usually sufficient to assign various degrees of intensities and priorities to specific behaviours. However, in a more complicated scenario, simply tweaking a behaviour's attribute may not produce acceptable results. In order to implement higher-level behaviour, an AIE needs to be able to make decisions about what actions to take according to its surrounding environment. According to the method 100, this is implemented via Action Selection.

The steering behaviour mechanisms described above allows controlling the behaviour of AIEs. However, an AIE often warrants greater intelligence. A method and system according to the present invention enables an animator to assign further behavioural detail to a character via Action Selection. Action Selection allows AIEs to make decisions for themselves based on their environment, where these decisions can modify the character's behaviour, drive its animation cycles, or update the character's memory. This allows the animator to control which behaviours or animation cycles are applied to an autonomous character and when.

Alternatively to assigning priorities to certain behaviours, a vision sensor is created for each autonomous fish 312 to determine whether the fish 312 sees a shark 304 or not.

FIG. 8 illustrates a decision tree 320 created and used to implement Action Selection for the fish 312. Therefore, during each think cycle, a vision sensor created for each fish 312 produces a datum true or false in response to the question; Do I see a shark? 322. A set of rules is then created for the AIE (the fish 312) to apply to the data to be gathered from the vision sensor. For instance, if a fish 312 sees a shark 304 then it should swim away from the shark 304 (step 324) and the “Flee From” shark behaviour is activated. If not, then the fish 312 should flock with any similar fish 312 within thirty centimeters (step 328) and its “Flock With” other fish behaviour is activated (step 330). To further enhance the simulation, other decision trees could be used to activate and control animation clips as well as simulation logic.

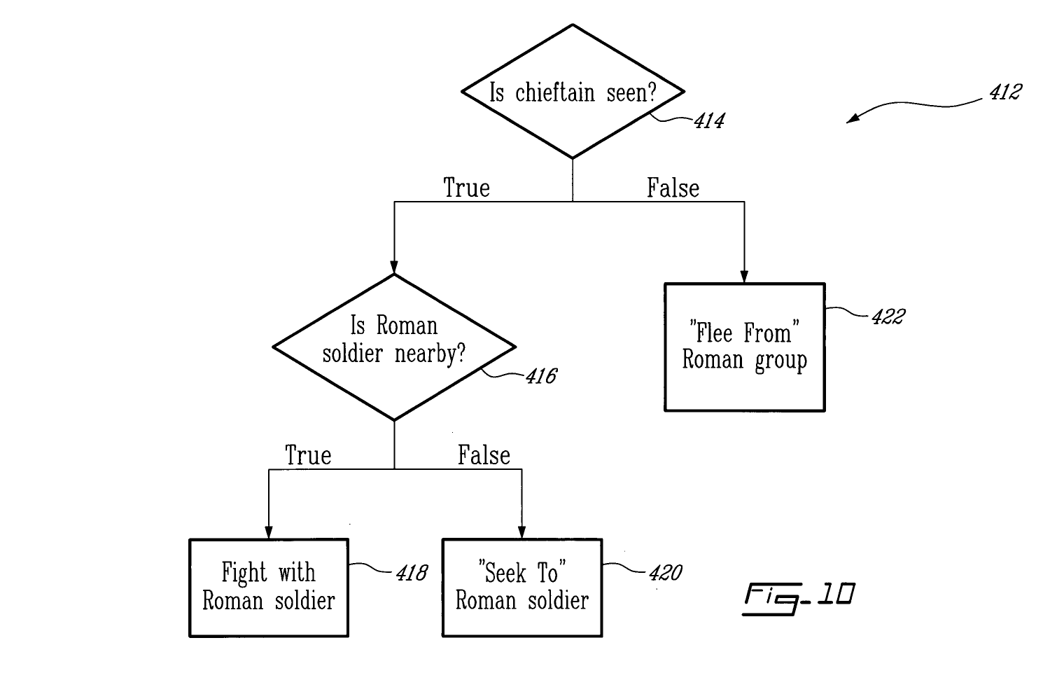

The method 100 will now be described by way of a second specific example of application related to the animation of characters in a battle scene with reference to FIGS. 9-14.

Film battles typically involve two opposing armies who run towards each other, engage in battle, and then fight until one army weakens and is defeated. Given the complexity, expense, and danger of live filming such scenes, it is clear that an effective AI animation solution is preferable to staging and filming such battles with actual human actors.

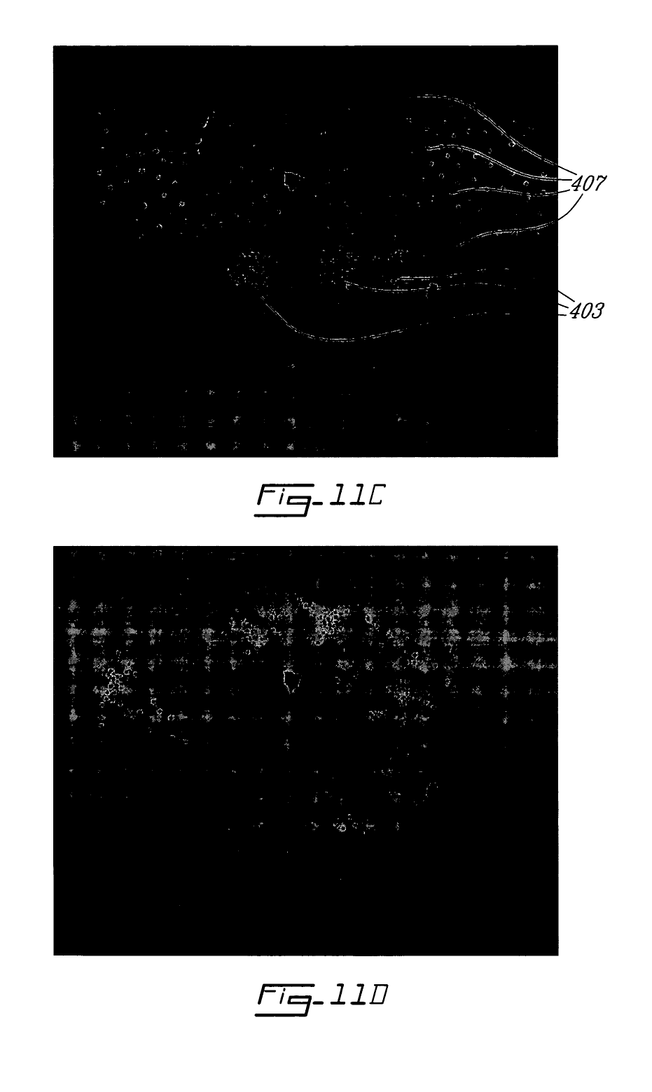

The present example of application of the method 100 involves an army 401 of 250 disciplined Roman soldiers 403, composed of 10 units led by 10 leaders, against a horde 405 of 250 beast warriors 407 composed of 10 tribes lead by 10 chieftains. The scenario is as follows. The Romans 403 are disciplined soldiers who marched slowly in formation until the enemy is very close. Once within fighting range, the Romans 403 break ranks and attack the nearest beast warrior 407 (see for example FIG. 11C). The Romans 403 never retreat and will fight until either themselves or their enemy have all been killed. The beast warriors' tactics are completely opposite to the Romans'. The beast warrior chieftains run at full speed towards the Roman army 401 and attack the closest soldier 403 they find. Individual beast warriors 407 follow their chieftain and fight the Romans 403 as long as their chieftain is alive. Once their chieftain is killed, they retreat.

The following description outlines how the method 100 can be used to animate this battle scene. Firstly, group behaviour and the binary decision tree that determines what actions the characters 403 and 407 will make are defined. Secondly, individual character behaviour and the binary decision tree to ensure that the correct animation cycle is played at the correct time are defined.

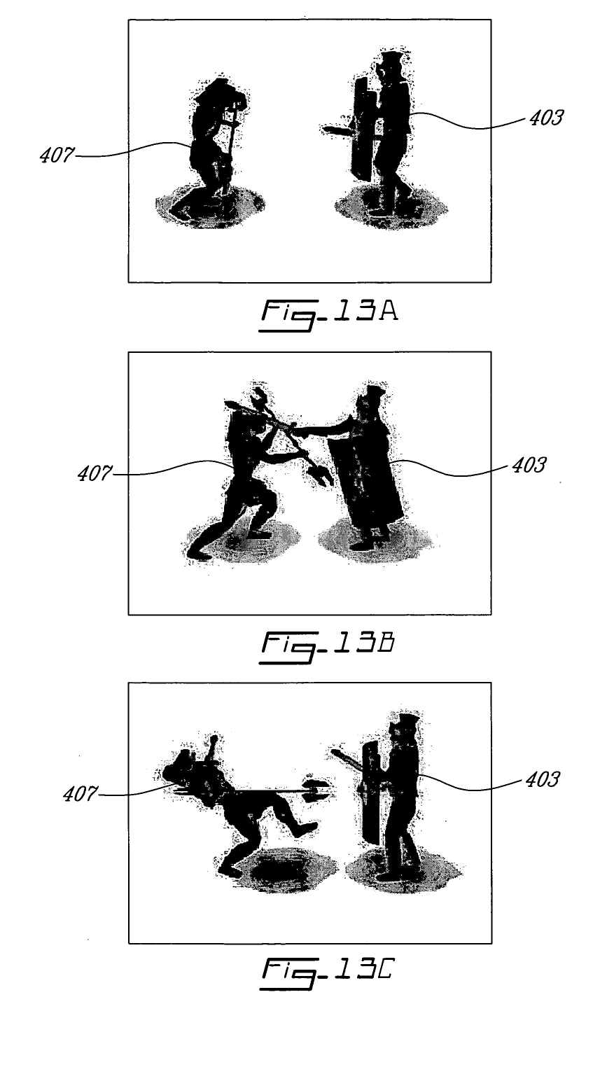

In a battle involving hand-to-hand combat (see FIG. 13A-13C), there are typically two different ways for enemy groups to engage one another: marching in a tight, often geometric, formation or running together in a basic horde. Being disciplined soldiers the Romans 401 choose the first manner, while the beast warrior tribes 405 the second.

The Roman soldiers 403 and their leaders behave in exactly the same manner. As summarized in FIG. 9, they are made to march in formation by initially laying them out in the correct geometric formation and then applying a simple “Maintain Speed At” behaviour to start them marching and an “Orient To” beast warriors behaviour to point them in the right direction. Once the soldiers 403 are sufficiently close to the opposing beast warriors 407, these behaviours are de-activated by their binary decision trees and replaced by their tactical behaviours, as illustrated with the decision tree 400 of FIG. 9. In order to deactivate and activate the soldiers' behaviours, sensors are used to determine specific datum points. For example, to determine if a soldier 403 sees a beast warrior we create a vision sensor to answer the question “Do I see a beast warrior?” (step 402). To this question the sensor will return either true or false. Based on this response, the soldier 403 will decide how to act. If the soldier 403 sees a warrior 407, he will determine if the warrior 407 is within fighting distance (step 404). If so, he will attack the warrior 407 (step 406), if not he will “Seek To” the warrior (step 408). If the soldier 403 does not see a warrior 407, he will continue marching towards beast warriors 407 (step 410).

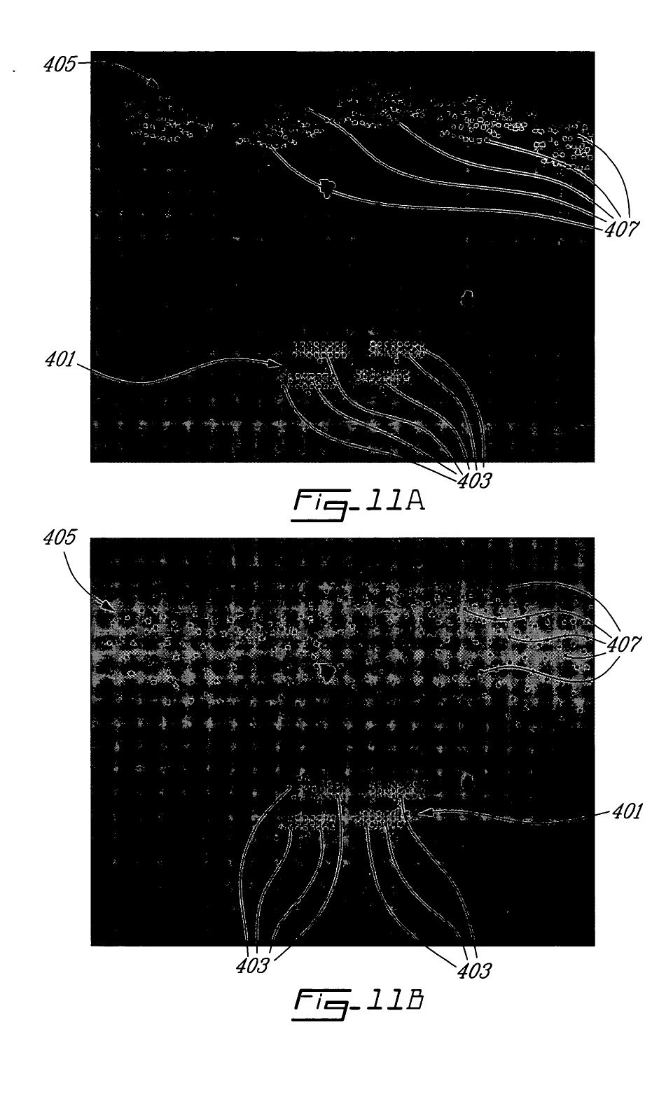

In contrast to the Romans 403, the beast warriors 407 run towards their enemy as a pack. The beast warrior chieftains are made to run towards the Romans 401 by setting their behaviour as “Seek To” the group of Romans at maximum speed. The beast warriors 407 in turn follow their chieftains via a “Seek To” chieftain behaviour. Once the beast warriors 407 are within range of the Roman soldiers 403, these behaviours are de-activated by their binary decision trees and replaced by their tactical behaviours, in much the same manner as we previously did for the Roman soldiers. The tactical behaviour binary decision tree 412 for a beast warrior 407 is illustrated in FIG. 10. If a beast warrior 407 sees his chieftain, (step 414) i.e. the chieftain is still alive, he will fight with any Roman soldier 403 (step 418) who is within fighting distance (step 416), or “Seek To” the closest soldier if no soldier is nearby (420). If a chieftain is killed, the beast warriors 407 of his tribe will run away from the surrounding Romans with a “Flee From” group of Romans behaviour (Step 422). The fight behaviour of the chieftains is the same as for their warriors 407, except that obviously they do not first determine if they see their chieftain before determining if a Roman soldier is within fighting distance.

The binary decision trees illustrated in FIGS. 9 and 10 generally dictate how the 250 Roman soldiers and the 250 beast warriors engage in battle. When the animation is run, the battle would typically proceed as shown in FIGS. 11A-11D. These screen shots are taken from a complete battle animation.

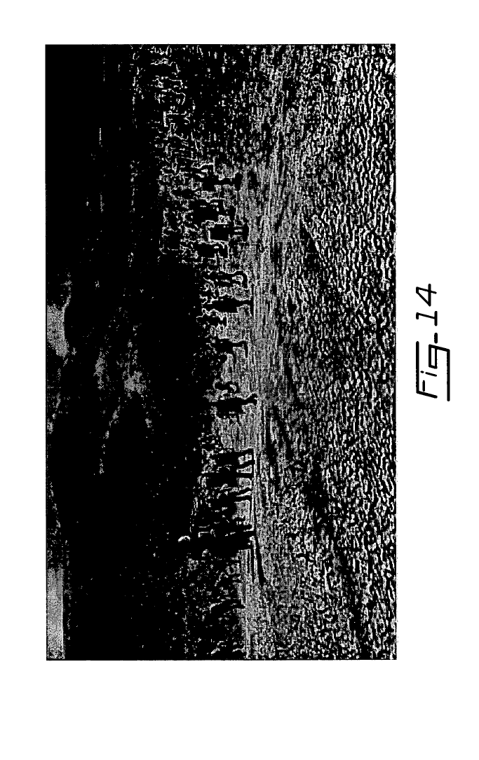

Once the gross motion of the battle is complete, the close-up hand-to-hand combat remains to be animated (see FIGS. 13A-13C and 14). Although each character is very small in the final shot, it is important for special effects artists to have the most realistic scene possible.

The decision trees illustrated in FIGS. 9 and 10 end as the character is about to fight an enemy character. As the real battle doesn't stop there the manner in which each character engages in hand-to-hand combat is to be determined. The Romans 403 and beast warriors 407 according to the present example fight in similar fashions. Once a character is within striking range of its target, the enemy, the binary decision tree for the fight sequence randomly chooses between an upper and lower weapon attack. If the attack is unsuccessful the character keeps fighting until it either kills its enemy or is killed itself. If the attack is successful, then the target character plays its dying animation sequence that corresponds to how it was attacked. For example, if a character was killed via an upper weapon attack it will play its upwards dying sequence, and if the attack was a lower weapon attack, it will play its downwards dying sequence.

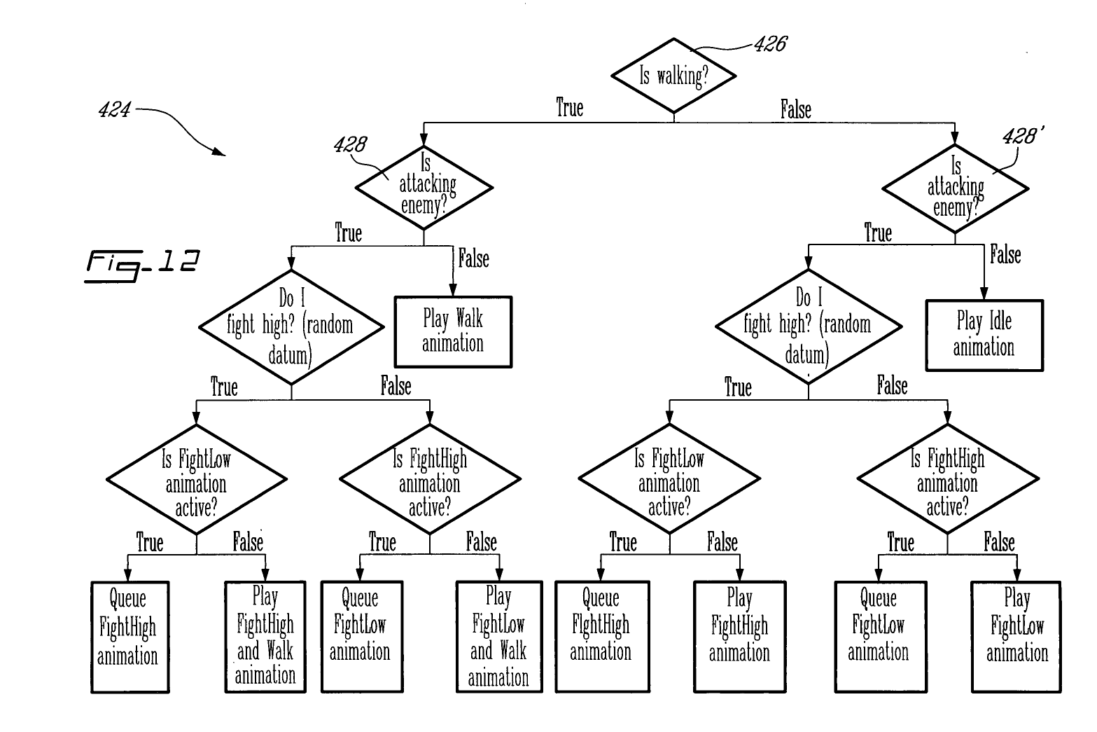

In order to play the correct animation sequence for each character during each fight sequence, the binary decision tree 424 shown in FIG. 12 is implemented. This decision tree 424 determines which animation clip to play and at what time according to the actions that the character performs. The decision tree 424 is created in a similar manner as the behaviour decision trees previously discussed, in that datum points are created and sensors are used to determine the data. However, instead of changing the behaviour of the character, the output of the decision tree determines which animation clip to play.

In this example, it is first determined whether a character is walking or not via a speed sensor (step 426). The information returned from the sensor allows determining whether a walk or idle animation sequence should be played. It is then determined whether the character is attacking the enemy or not (428-428′). This information allows determining whether a fight animation is to be played. In order to choose which fight animation to play (FightHigh or FightLow), a random sensor is used to randomly return true or false each cycle. As the binary decision tree does not guarantee that a FightHigh animation sequence will be completed before a FightLow sequence is played, or vice versa, a given animation sequence is queued if another one is currently active. This ensures that a given fight animation sequence is completed before the next sequence commences. As each type of character has different animation sequences, the decision tree 424 is duplicated for each type of character and the correct animation sequences are associated thereto.

The animation sequence resulting from the second example can be completed by creating a decision tree for the dying sequence of each character. Then the required number of characters necessary to fill the battleground is duplicated and the animation is triggered. The screen shots shown in FIGS. 13a-13c and in FIG. 14 are taken from the battle animation according to the second example.

The method 100 will now be described in more detail with reference to other specific examples of applications related to the animation of entities.

An animation logic wherein two humans walk through a narrow corridor cluttered with crates that they must avoid will now be considered, the elements defining the scene being:
two humans, defined as AIE;
an animation cycle associated to each humans to drive their walking animation;
a path stretching from one end of the corridor to the other;
the crates being non-autonomous entities;
the two humans being initially assigned the behaviour “Follow Path” so that they follow the path, and the behaviour “Avoid Obstacles” in order to avoid the crates. Since the crates are non-autonomous entities, they can move around in real-time resulting in the characters adjusting their position. Optionally, the motion of the crates can be driven with another system, such as rigid-body dynamics; and
the walls of the corridors are defined as barriers; the two humans further being assigned an “Avoid Barriers” behaviour so that they do not walk into the walls.

Another example includes characters moving as a group. Group behaviours enable grouping individual autonomous characters so that they act as a group while still maintaining individuality. According to this example, a group of soldiers are about to launch an attack on their enemy in open terrain.

The soldiers are defined as AIEs and any obstacles, such as trees and boulders, are defined as non-autonomous entities.

As the ground is not perfectly flat, a flat terrain is created and the height fields of various points are modified to give the terrain some elevation. To ensure that the soldiers remain on the ground it is provided that they hug the terrain.

To prevent the soldiers from walking into obstacles each soldier is assigned an “Avoid Obstacles” behaviour.

To ensure that the soldiers remain as a unit they are also assigned a “Flock With” behaviour that would specify how closely they keep together.

A “Seek To” the enemy behaviour is finally assigned to make the soldiers move towards their enemy.

According to a further example, there is provided a car race between several cars that occurs on a racetrack.

The cars are defined as AIEs. Each car is defined by specifying different engine parameters (max. acceleration, max. speed, etc.) so that they each race slightly differently.

As the racetrack is not perfectly flat, a flat terrain is first created within the digital world and then the height fields are changed at various points to give the terrain some elevation. To ensure that the cars stay on the surface of the track, it is specified that the cars hug the terrain.

A looped path that follows the track is provided and the cars are assigned a “Follow Path” behaviour so that they stay on the racetrack. Each waypoint along the path is characterized by a speed limit associated to it (analogous to real gears at turns) that would limit the speed at which a car could approach the waypoint.

To prevent the cars from crashing into each other, each car is further characterized by an “Avoid Obstacles” behaviour as each car can be considered an obstacle to the other cars.

Finally, in order to keep the cars from straying too far off the racetrack, hidden barriers are added along the sides of the track and an “Avoid Barriers” behaviour is assigned to each car.

The next example concerns a skateboarder in a skate park.

The skateboarder is defined as an AIE and the various obstacles within the park, such as boxes and garbage bins, as obstacles. The ramps upon which the skateboarder can skate are defined as surfaces and to ensure that the skateboarder remains on a ramp surface rather than pass through it, it is specified that he hug the surface.

As discussed hereinabove, for AIEs to be able to make decisions for themselves based on information about their surrounding environment, Action Selection is implemented. For example, a guard patrolling a fortified compound against intruders is now provided as an example of animation according to the method 100.

The guard is defined as an AIE, the buildings and perimeter fence as barriers, and the trees, vehicles etc. within the compound as non-autonomous entities. A flat terrain is first created and then the height fields of various points are modified to give the terrain some elevation. To ensure that the guard remains on the ground it is specified that he hugs the terrain.

To prevent the guard from walking into obstacles within the compound during his patrol, an “Avoid Obstacles” behaviour is assigned thereto. In addition, to prevent him from walking into the perimeter fence or any of the buildings, he is also assigned an “Avoid Barriers” behaviour.

To specify the route that the guard takes during his patrol, a waypoint network is provided and the guard is assigned a “Seek To Via Network” behaviour. A waypoint network rather than a path is used to prevent the guard from following the exact same path each time. Via the network, the guard dynamically navigates his way around the compound according to the surrounding environment.

Sensors are created allowing the guard to gather data about his surrounding environment and binary decision trees are used to decide what actions to take to enable the guard to make decisions about what actions to take. For instance, sensors are created to enable the guard to hear and see in his surrounding environment. If he heard or saw something suspicious he would then decide what to do via a binary decision tree. For example, if he heard something suspicious during his patrol, he moves towards the source of the sound to investigate. If he didn't find anything, he returns to his patrol and continue to follow the waypoint network. If he did find an intruder, he fights the intruder. Further sensors and binary decision trees can be created to enable the guard to make other pertinent decisions.

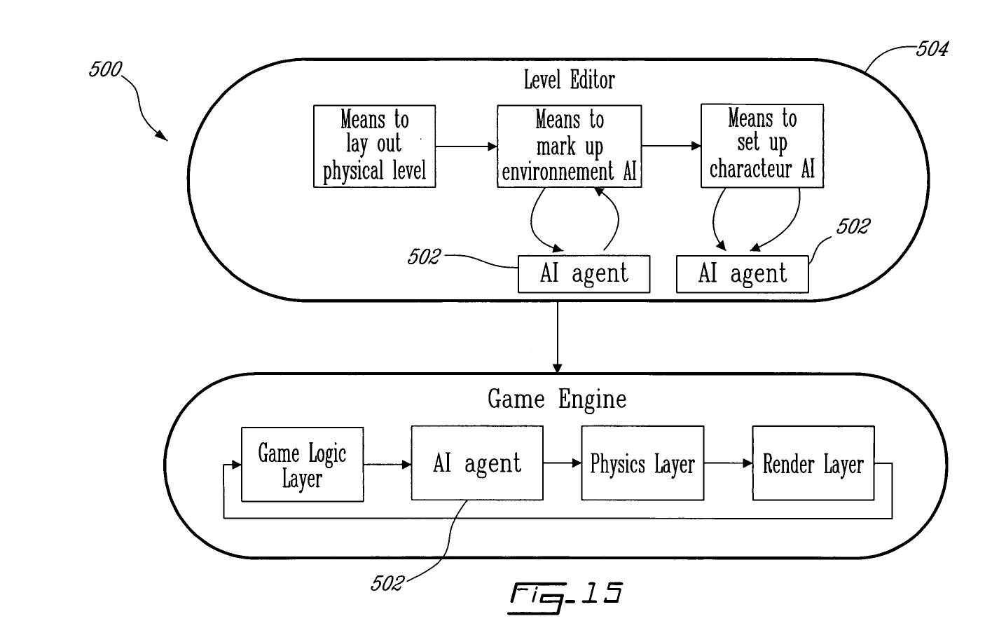

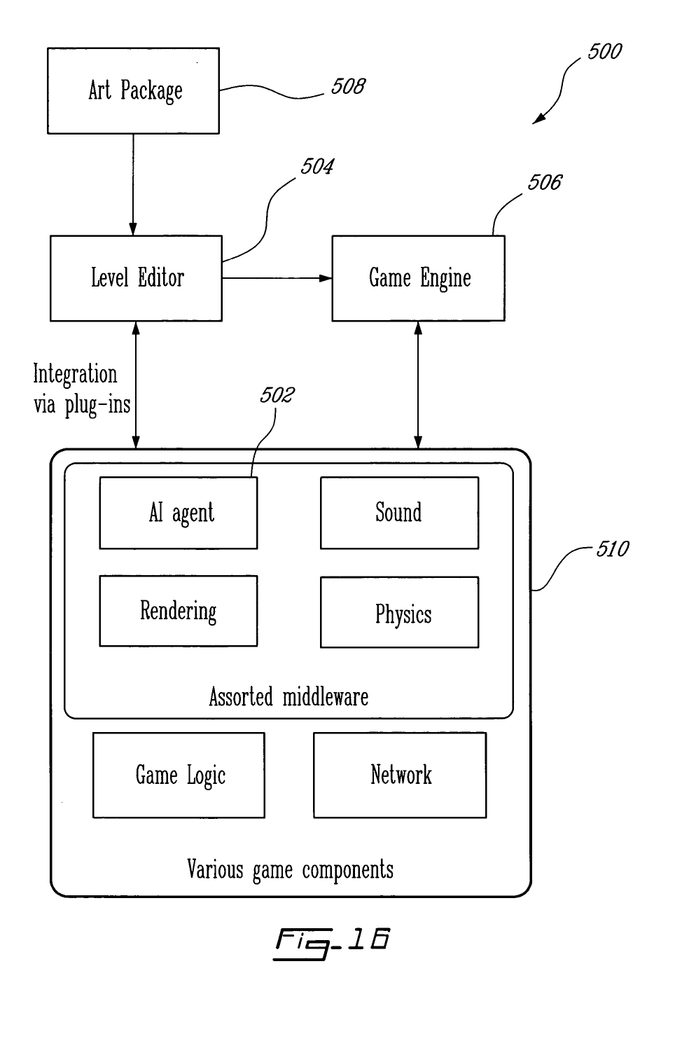

FIGS. 15 and 16 describe a system 502 for on-screen animation of digital entities according to a second illustrative embodiment of the second aspect of the present invention. This second illustrative embodiment of the second aspect of the present invention concerns on-screen animation of entities in a video game.

The system 502 is in the form of an AI agent engine to be included in a video game platform 500. The AI agent 502 is provided in the form of a plug-in for the video game platform 500. Alternatively, the AI agent can be made integral to the platform 500.

The AI agent 502 comprises programming tools for each aspect of the game development, including visual and interactive creation tools for level edition and an extensible API (Application Programming Interface).

More specifically, the game platform 500 includes a level editor 504 and a game engine 506. As it is well known in the art, a level editor is a computer application allowing creating and editing the “levels” of a video game. An art package (or art application software) 508 is used to create the visual look of the digital world including the environment, autonomous and non-autonomous image entities that will inhabit the digital world. Of course, an art package is also used to create the looks of digital entities in any application, including movies. Since art packages and level editors are both believed to be well known in the art, they will not be described herein in more detail.

As illustrated in FIG. 16, the game platform 500 further includes libraries 510 allowing a game programmer to integrate the AI engine 502 into an existing game engine 506. The AI engine 502 can be either authored directly by the game programmer by calling low-level behaviours or in the level editor using game designer friendly tools whose behaviour can be pre-visualized in the level editor 504 and exported directly to the game engine 506.

The libraries 510 provides an open architecture that allows game programmers to extend the AI functionality such as adding their own programmed behaviours.

The libraries 510, including the AI agent 502, allows for the following functionality:

1—Real-time authoring tools for level editors:

The libraries allow creating, testing and editing character logic in art package/level editor and to be exported directly to the game engine.

As discussed hereinabove, the libraries can be integrated via plug-in or directly into a custom editor or game engine.

The implementation of the creating tools in the form of librairies allows for real-time feedback to shorten the design to production cycle.

2. Multi-platform:

The use of libraries allows to first author animations and then to publish them across many game platforms, such as Playstation 2™ (PS2), Xbox™, GameCube™, Personal Computer (PC) implementing Windows 98™, Windows 2000™, Windows XP™, or Linux™, etc.

3. High performance:

The use of libraries allows minimizing central processing unit (CPU) and memory usage.

It allows optimizing the animation for each platform.

4. Open, flexible and extendable AI architecture:

The modularity provided with the use of libraries allows using only the tools required to perform the animation.

5. Piggyback the physics layer to avoid duplicate world mark-up and representation and gain greater performance and productivity:

The use of libraries allows the AI agent to use the physics layer for barriers, space partition, vision sensing, etc.

It also allows for less environmental mark-up, faster execution, less data, less code in the executable, etc.

6. Detailed integration examples of genres (e.g., action/adventure, racing, etc.) and of other middleware solutions (e.g., Renderware™, Havok™, etc.):

For each genre, the plug-in 502 is used to author the example. Among the covered genres include First Person Shooter (FPS), action/adventure, racing and fishing. For each genre, examples are authored and documented. This is similar for film application, where the genres include battle scene, hand-to-hand combat, large crowd running, etc.

For other middleware solutions, the AI agent 502 is basically integrated therewith. For physics, it can be integrated, for example, with Havok's™ physics middleware by taking one of its demo engines, ripping out its hardwired AI agent and replacing it with the AI agent 502. For rendering middleware (GameBryo™ from NDL and Criterion's RenderWare), their software are used and simple game engines are built and the AI agent is linked into them.

7. Intelligent animation control feeds the animation engine:

Based on character decisions, animation clip control (selection, scaling, blending) is transferred to the developer animation engine. The inputs include user defined rules, and the outputs include dynamic information fro each animation frame based on AI for that frame of exactly which animation cycles to play, how they are to be blending, etc.

A system for on-screen animation of digital entities, including characters, according to the present invention, allows creating and animating non-player characters and opponents, camera control, and realistic people or vehicles for training systems and simulations. Camera control can be created via an intelligent invisible character equipped with a virtual hand-held camera, yielding a camera that seemingly follows the action.

A system for on-screen animation of digital entities according to embodiments of the present invention includes user-interface menus allowing a user selecting and assigning predetermined attributes and behaviours to an AIE.

Also, according to some embodiments, the system for on-screen animation of digital entities includes means for creating, editing and assigning a decision tree to an AIE.

Of course, many user-interface means can be used to allow copying and pasting of attributes from a graphical representation of a digital entity to another. For example, a mouse cursor and mouse buttons or a user menu can be used to identify the source and destination and to select the attribute to copy.

A method and system for on-screen animation of digital entities can be used to animate digital entities in a computer game, in computer animation for movies, and in computer simulation applications, such as a crowd emergency evacuation.

Although the present invention has been described hereinabove by way of preferred embodiments thereof, it can be modified, without departing from the spirit and nature of the subject invention as defined in the appended claims.

1. A method for on-screen animation of digital entities comprising:
providing a digital world including image object elements;
providing at least one autonomous image entity (AIE); each said AIE being associated with at least one AIE animation clip, and being characterized by a) attributes defining said at least one AIE relatively to said image objects elements, and b) at least one behaviour for modifying at least one of said attributes; said at least one AIE including at least one virtual sensor for gathering data information about at least one of said image object elements or other one of said at least one AIE;
initializing said attributes and selecting one of said behaviours for each of said at least one AIE;
for each said at least one AIE:
using said at least one sensor to gather data information about at least one of said image object elements or other one of said at least one AIE; and
using a decision tree for processing said data information resulting in at least one of i) triggering one of said at least one AIE animation clip according to said attributes and selected one of said at least one behaviour, and ii) selecting one of said at least one behaviour.

2. A method as recited in claim 1, wherein said at least one AIE being associated with a memory for storing said data information; said using a decision tree for processing said data information resulting in at least one of i) triggering one of said at least one AIE animation clip according to said attributes and selected one of said at least one behaviour, ii) selecting one of said at least one behaviour, and iii) modifying said memory.

3. A method as recited in claim 1, further comprising creating a group of AIEs; wherein said using a decision tree for processing said data information resulting in at least one of i) triggering one of said at least one AIE animation clip according to said attributes and selected one of said at least one behaviour, ii) selecting one of said at least one behaviour, and iii) adding said at least one AIE to said group of AIEs.

4. A method as recited in claim 1, wherein said attributes defining said at least one AIE relatively to said image object elements include at least one of:
an “exists” attribute for triggering the existence of said at least one AIE within said digital world;
a “collidable” attribute for allowing said at least one AIE to collide with other AIE or with at least one of said image objects elements;
the radius of a bounding sphere of said at least one AIE;
a maximum right turning angle per frame of said at least one AIE;
a maximum left turning angle per frame of said at least one AIE;
a maximum up turning angle per frame of said at least one AIE;
a maximum down turning angle per frame of said at least one AIE;
a maximum positive change in angular speed of said at least one AIE in degrees per frame²;
a maximum negative change in angular speed of said at least one AIE in degrees per frame²;
a maximum angle of deviation from an axis defined within said digital world that a top vector from said at least one AIE have;
a minimum speed in distance units per frame of said at least one AIE;
a maximum speed in distance units per frame of said at least one AIE;
a maximum positive change in speed in distance units per frame² of said at least one AIE;
a maximum negative change in speed in distance units per frame² of said at least one AIE;
an initial speed of said at least one AIE in distance units per frame when initializing said attributes;
an initial position of said at least one AIE in distance units per frame when initializing said attributes;
an initial orientation of said at least one AIE in distance units per frame when initializing said attributes; and
a current speed in distance units per frame of said at least one AIE.

5. A method as recited in claim 1, wherein said image object elements include two-dimensional or three-dimensional graphical representations of a surface; said attributes including at least one of:
an attribute defining whether or not said least one AIE hugs said surface;
an attribute allowing setting whether or not said least one AIE aligns with a normal of said surface; and
an attribute defining an extra height given to said at least one AIE relatively to said surface when said at least one AIE hugs said surface.

6. A method as recited in claim 5, wherein said surface is a barrier.

7. A method as recited in claim 1, wherein said image object elements include two-dimensional or three-dimensional graphical representations of at least one of an object, a non-autonomous character, a building, a barrier, a terrain, and a surface.

8. A method as recited in claim 7, wherein said barrier is defined by a forward direction vector and is used to restrain the movement of at least one of said at least one AIE in a direction opposite said forward direction vector.

9. A method as recited in claim 7, wherein said barrier is a three-dimensional barrier defined by triangular planes.

10. A method as recited in claim 7, wherein said barrier is a two-dimensional barrier defined by a line.

11. A method as recited in claim 7, wherein said terrain are two-dimensional height-fields representation for bounding AIEs.

12. A method as recited in claim 7, wherein said surface includes triangular planes combinable so as to form three-dimensional shapes for constraining AI Es.

13. A method as recited in claim 7, wherein said at least one behaviour causes said at least one AIE to avoid said barrier.

14. A method as recited in claim 1, wherein said digital world is defined by parameters selected from the group consisting of a width, a depth, a height, and a center position.

15. A method as recited in claim 1, wherein said attributes include at least one internal state attribute defining a non-apparent characteristic of said at least one AIE; said at least one behaviour is a state change behaviour for modifying said at least one internal state attribute.

16. A method as recited in claim 1, wherein said at least one behaviour is a locomotive behaviour for causing said at least one AIE to move.

17. A method as recited in claim 1, wherein said at least one behaviour includes a plurality of behaviours; each of said plurality of behaviours producing a behavioural steering force defined by an intensity;
whereby, in operation, each of said plurality of behaviours producing a steering force on said at least one AIE proportionate to said intensity.

18. A method as recited in claim 1, wherein said at least one behaviour includes a plurality of behaviours; each of said plurality of behaviours producing a behavioural steering force and being assigned a priority;
whereby, in operation, each of said plurality of behaviours being assigned to said at least one AIE by descending priority.

19. A method as recited in claim 1, wherein said at least one behaviour being characterized by a blend time defining a number of frame that said at least one behaviour take to change from an active state to an inactive state.

20. A method as recited in claim 1, wherein said at least one behaviour is triggered based on one of said AIE's attributes.

21. A method as recited in claim 20, wherein said at least one behaviour is triggered based on a distance of said at least one AIE to one of said image object elements and another AIE.

22. A method as recited in claim 20, wherein said at least one behaviour is characterized by an activation radius defining the minimal distance between said at least one AIE and said targeted one of said image object elements.

23. A method as recited in claim 20, wherein said at least one behaviour causes said at least one AIE to perform an action selected form the group consisting of:
moving towards another AIE;
fleeing from another AIE;
looking at another AIE;
orbiting said targeted one of said image object elements or another AIE;
aligning with at least one another AIE;
joining with at least one another AIE; and
keeping a distance to at least one another AIE.

24. A method as recited in claim 1, wherein said at least one behaviour further modifying a targeted one of said image object elements or another AIE.

25. A method as recited in claim 1, wherein said at least one behaviour causes said at least one AIE to perform an action selected form the group consisting of:
avoiding one of said image object elements or another AIE;
accelerating said at least one AIE;
maintaining a constant speed;
moving randomly within a selected portion of said digital world; and
attempting to face a predetermined direction.

26. A method as recited in claim 1, wherein said at least one virtual sensor is a vision sensor for detecting said at least one of said image object elements or another one of said at least one AIE when said at least one of said image object elements or another one of said at least one AIE is within a predetermined distance from said at least one AIE and within a predetermined frustum issued therefrom.

27. A method as recited in claim 1, wherein said at least one virtual sensor is a property sensor for detecting at least one attribute of said other one of said at least one AIE.

28. A method as recited in claim 1, wherein said at least one virtual sensor is a random sensor returning a random number within a specified range.

29. A method as recited in claim 1, wherein said data information is stored in a datum.

30. A method as recited in claim 29, wherein said virtual sensor allows for setting a value stored in said datum based on one of said attributes.

31. A method as recited in claim 29, wherein said virtual sensor allows for setting a value stored in said datum based on whether or not a predetermined one of said at least one AIE animation clip is triggered.

32. A method as recited in claim 1, wherein in i) said at least one AIE animation clip is triggered after an active animation associated to said at least one AIE is completed.

33. A method as recited in claim 1, wherein in i) a number of frame that said at least one animation clip will take to perform is provided before said at least one animation clip is triggered.

34. A method as recited in claim 1, wherein said attributes include the speed of said at least one AIE; in i) said at least one AIE animation clip being played at a speed depending on said speed of said at least one AIE.

35. A method as recited in claim 1, wherein in i) said at least one animation clip is scaled and a number of cycle is provided for said at least one animation clip before said at least one animation clip is triggered.

36. A method as recited in claim 1, wherein in i) if one of said at least one animation clip associated to said at least one AIE plays before said at least one animation clip is triggered then playing an animation transition before said at least one animation clip is triggered.

37. A method as recited in claim 1, wherein in i) if one of said at least one animation clip associated to said at least one AIE plays before said at least one animation clip is triggered then said at least one animation clip is triggered and a blend animation is created between said one of said at least one animation clip associated to said at least one AIE playing before said at least one animation clip is triggered and said at least one animation clip.

38. A method as recited in claim 1, wherein said digital world includes at least one marking for modifying on contact at least one of said attributes and said at least one behaviour of said at least one AIE.

39. A method as recited in claim 38, wherein said at least one marking is defined by a bounding sphere having a radius.

40. A method as recited in claim 38, wherein said digital world includes a plurality of linked markings defining a path.

41. A method as recited in claim 40, wherein said at least one behaviour causes said at least one AIE to use said path to navigate within said world towards one of said image object elements.

42. A method as recited in claim 40, wherein some of said plurality of markings are linked with edges so as to define a waypoint network; and edge between two of said plurality of linked markings allowing said at least one AIE to move between said two of said plurality of linked markings.

43. A method as recited in claim 42, wherein said two of said plurality of linked markings being consecutive.

44. A method as recited in claim 42, wherein said at least one behaviour causes said at least one AIE to use said waypoint network to navigate within said world towards one of said image object elements.

45. A system for on-screen animation of digital entities comprising:
an art package to create a digital world including image object elements and at least one autonomous image entity (AIE) and to create AIE animation clips;
an artificial intelligence agent to associate to an AIE a) attributes defining said AIE relatively to said image objects elements, b) a behaviour for modifying at least one of said attributes, c) at least one virtual sensor for gathering data information about at least one of said image object elements or other AIEs, and d) an AIE animation clips; said artificial intelligence agent including an autonomous image entity engine (AIEE) for updating each AIE's attributes and for triggering for each AIE at least one of a current behaviour and one of said at least one animation clip based on said current behaviour and said data information gathered by said at least one sensor.

46. A system as recited in claim 45, further comprising a user interface for displaying and editing at least one of said at least one AIE and said image object elements.

47. A system as recited in claim 46, further comprising a duplicating tool to simultaneously edit a plurality of AIEs.

48. An artificial intelligence agent for on-screen animation of digital entities comprising:
means to associate to an AIE a) attributes defining said AIE relatively to said image objects elements, b) a behaviour for modifying at least one of said attributes, c) at least one virtual sensor for gathering data information about at least one of said image object elements or other AIEs, and d) an AIE animation clips; and
an autonomous image entity engine (AIEE) for updating each AIE's attributes and for triggering for each AIE at least one of a current behaviour and one of said at least one animation clip based on said current behaviour and said data information gathered by said at least one sensor.

49. A system for on-screen animation of digital entities comprising:
means for providing a digital world including image object elements;
means for providing at least one autonomous image entity (AIE);
each said AIE being associated with at least one AIE animation clip, and being characterized by a) attributes defining said at least one AIE relatively to said image objects elements, and b) at least one behaviour for modifying at least one of said attributes; said at least one AIE including at least one virtual sensor for gathering data information about at least one of said image object elements or other one of said at least one AIE;
means for initializing said attributes and selecting one of said behaviours for each of said at least one AIE;
means for using said at least one sensor to gather data information about at least one of the image object elements or other one of said each said at least one AIE;
means for using a decision tree for processing said data information;
means for triggering one of said at least one AIE animation clip according to said attributes and selected one of said at least one behaviour; and
means for selecting one of said at least one behaviour.
